(19) United States
(12) Patent Application Publication
(10) Pub. No.: US 2016/0295580 A1
(43) Pub. Date: Oct. 6, 2016

(54) ADAPTIVE SHORT INTER-FRAME SPACE BURSTING

(71) Applicant: QUALCOMM Incorporated, San Diego, CA (US)

(72) Inventors: Srinivas Katar, Fremont, CA (US); James Simon Cho, Mountain View, CA (US); Guido Frederiks, Aptos, CA (US); Qinghai Gao, Sunnyvale, CA (US); Xiaolong Huang, San Jose, CA (US); Chao Zou, Ocala, FL (US); Rahul Malik, San Diego, CA (US)

(21) Appl. No.: 14/678,652

(22) Filed: Apr. 3, 2015

(51) Int. Cl. H04W 72/04; H04W 52/02; H04W 24/08

(52) U.S. Cl. CPC H04W 72/0446; H04W 24/08; H04W 52/0235

(57) ABSTRACT

Methods, systems, and devices are described for wireless communication at a wireless device. A wireless device (e.g., station or access point) may adapt short inter-frame space (SIFS) burst parameters to improve the performance of the overall network while providing enriched user experience. A wireless device may monitor traffic conditions on the network and dynamically adapt the SIFS burst parameters associated with one or more stations based at least in part on detected variations on the traffic channel. In other examples, the wireless device may allocate a common SIFS burst parameter to be used by a plurality of wireless devices in the basic service set (BSS).

### BACKGROUND

1. Field of Disclosure

The following relates generally to wireless communication, for example to adaptive short inter-frame space bursting.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless network, for example a wireless local area network (WLAN), may include an access point (AP) that may communicate with one or more stations (STAs) or mobile devices. The AP may be coupled to a network, such as the Internet, and may enable a mobile device to communicate via the network (or communicate with other devices coupled to the access point in a service set, e.g., a basic service set (BSS) or extended service set (ESS)). A wireless device may communicate with a network device bi-directionally. For example, in a WLAN, a STA may communicate with an associated AP via downlink (DL) and uplink (UL). From the STA's perspective, the DL (or forward link) may refer to the communication link from the AP to the station, and the UL (or reverse link) may refer to the communication link from the station to the AP. In some cases, a STA may implement burst transmission to improve STA throughput without relinquishing control of the medium. However, burst transmissions by a single STA may adversely impact performance of other STA(s) on the network, for example, by preventing the other STA(s) from obtaining timely access to the medium, thereby degrading the overall performance of the network.

### SUMMARY

The present disclosure may relate to systems, methods, or apparatuses for adaptive short inter-frame space (SIFS) bursting. Specifically, in accordance with the present disclosure, a wireless device (e.g., STA or AP) may adapt SIFS burst parameters to improve the performance of the overall network and provide an enriched user experience. A wireless device may monitor traffic conditions on the network and dynamically adapt the SIFS burst parameters associated with one or more STA(s) based at least in part on detected variations on the traffic channel. In other examples, the wireless device may allocate a common SIFS burst parameter to be used by a plurality of wireless devices in the basic service set (BSS).

A method of wireless communication at a device is described. The method may include monitoring traffic information on a channel, identifying a change in the monitored traffic information, and adapting a SIFS burst parameter based at least in part on the change in the monitored traffic information.

An apparatus for wireless communication at a device is described. The apparatus may include a network traffic monitor for monitoring traffic information on a channel, a traffic condition identifier for identifying a change in the monitored traffic information, and a SIFS burst adapter for adapting a SIFS burst parameter based at least in part on the change in the monitored traffic information.

A non-transitory computer-readable medium storing code for wireless communication at a device is described. The code may include instructions executable to monitor traffic information on a channel, identify a change in the monitored traffic information, and adapt a SIFS burst parameter based at least in part on the change in the monitored traffic information.

An apparatus of wireless communication at a device is described. The apparatus may include means for monitoring traffic information on a channel, means for identifying a change in the monitored traffic information, and means for adapting a SIFS burst parameter based at least in part on the change in the monitored traffic information.

The adapted SIFS burst parameter may be transmitted from a first wireless device to a second wireless device, wherein one of the wireless devices is an access point (AP) and the other of the wireless devices is a station. Additionally or alternatively, the adapted SIFS burst parameter may be transmitted to the second wireless device using a message from the group consisting of a management message and a beacon signal.

A message indicating SIFS bursting capabilities of the second wireless device may be received; and the SIFS burst parameter is based at least in part on the SIFS bursting capabilities of the second wireless device. A second BSS may be identified at a first wireless device of a first BSS, the second BSS overlapping with the first BSS. The first wireless device may communicate with a second wireless device of the second BSS to coordinate the SIFS burst parameter.

A common SIFS burst parameter to be used by a plurality of wireless devices in the first BSS and the second BSS may be determined, and the common SIFS burst parameter may be transmitted to the plurality of wireless devices. In some cases, SIFS burst transmissions may be disabled based at least in part on the identified change in the monitored traffic information.

A transmission opportunity (TXOP) duration or enhanced distributed channel access (EDCA) parameter may be adjusted based at least in part on the change in the monitored traffic information. In some cases, identifying the change in the monitored traffic information may include detecting at least one legacy station.

The SIFS burst parameter may be selected from the group consisting of a duration of an aggregate media access control protocol data unit (A-MPDU), number of A-MPDUs in a burst, a total duration of the burst, and an available bandwidth. Additionally or alternatively, the SIFS burst parameter may include a destination-specific SIFS burst parameter.

The monitored traffic information may be selected from the group consisting of an access category, a link direction, a number of stations in a BSS, a number of active flows in the BSS, traffic flow information, and a quality of service (QoS) requirement.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) for adaptive short inter-frame space bursting in accordance with various aspects of the present disclosure

FIG. 2 illustrates an example of a wireless communications subsystem for adaptive SIFS bursting in accordance with various aspects of the present disclosure;

FIG. 3 illustrates an example of communications between an AP and a STA for adaptive SIFS bursting in accordance with various aspects of the present disclosure;

FIGS. 4A and 4B illustrate an example of communications between an AP and STAs for adaptive SIFS bursting in accordance with various aspects of the present disclosure;

FIG. 5 shows a block diagram of a wireless device configured for adaptive SIFS bursting in accordance with various aspects of the present disclosure;

FIG. 6 shows a block diagram of a wireless device configured for adaptive SIFS bursting in accordance with various aspects of the present disclosure;

FIG. 7A shows a block diagram of a burst traffic manager configured for adaptive SIFS bursting in accordance with various aspects of the present disclosure;

FIG. 7B shows a block diagram of a burst traffic manager configured for adaptive SIFS bursting in accordance with various aspects of the present disclosure;

FIG. 8A illustrates a block diagram of a system including a device configured for SIFS bursting in accordance with various aspects of the present disclosure;

FIG. 8B illustrates a block diagram of a system including a device configured for SIFS bursting in accordance with various aspects of the present disclosure;

FIG. 9 shows a flowchart illustrating a method for adaptive SIFS bursting in accordance with various aspects of the present disclosure;

FIG. 10 shows a flowchart illustrating a method for adaptive SIFS bursting in accordance with various aspects of the present disclosure; and

FIG. 11 shows a flowchart illustrating a method for adaptive SIFS bursting in accordance with various aspects of the present disclosure.

FIG. 12A illustrates an example of communications between an AP and a STA for contention-free transmissions in accordance with various aspects of the present disclosure.

FIG. 12B illustrates an example of communications between an AP and a STA for contention-free transmissions in accordance with various aspects of the present disclosure.

FIG. 13 shows a block diagram of a wireless device configured for contention-free transmissions in accordance with various aspects of the present disclosure.

FIG. 14 shows a flowchart illustrating a method for contention-free transmissions in accordance with various aspects of the present disclosure.

### DETAILED DESCRIPTION

The described features generally relate to improved systems, methods, and/or apparatuses for adaptive short inter-frame space (SIFS) bursting. Burst transmissions may be used by wireless devices to transmit multiple aggregate media access control (MAC) protocol data units (A-MPDUs) without relinquishing control of the medium. However, while longer SIFS bursts (e.g., 10 msec burst) may improve throughput for the individual STA associated with the burst transmission, such transmissions may negatively impact user experience for other STA(s) on the network. For example, when a first STA occupies a medium for an extended period of time during a burst transmission, a second STA on the network may experience increased latency and degraded user experience due to the scarcity of transmission resources.

Accordingly, various techniques are described for adapting SIFS burst parameters based at least in part on monitored traffic conditions on the network. For example, when there is no latency sensitive traffic (e.g., voice over internet protocol (VoIP), gaming traffic, etc.) on the network, a STA may be permitted to use extended SIFS burst duration (e.g., greater than or equal to 10 msec) to conduct SIFS burst transmissions. Conversely, if a wireless device (e.g., AP or STA) detects latency sensitive traffic on the network, a SIFS burst duration for a STA may be reduced (e.g., to 2 ms or less) to accommodate traffic for other STA(s) on the network. As a result, a time duration associated with a SIFS (i.e., the time interval between transmitting a data frame and receiving an acknowledgment (ACK) frame for the transmitted frame) may be dynamically modified based at least in part on active monitoring of the on-going traffic flow in the network.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

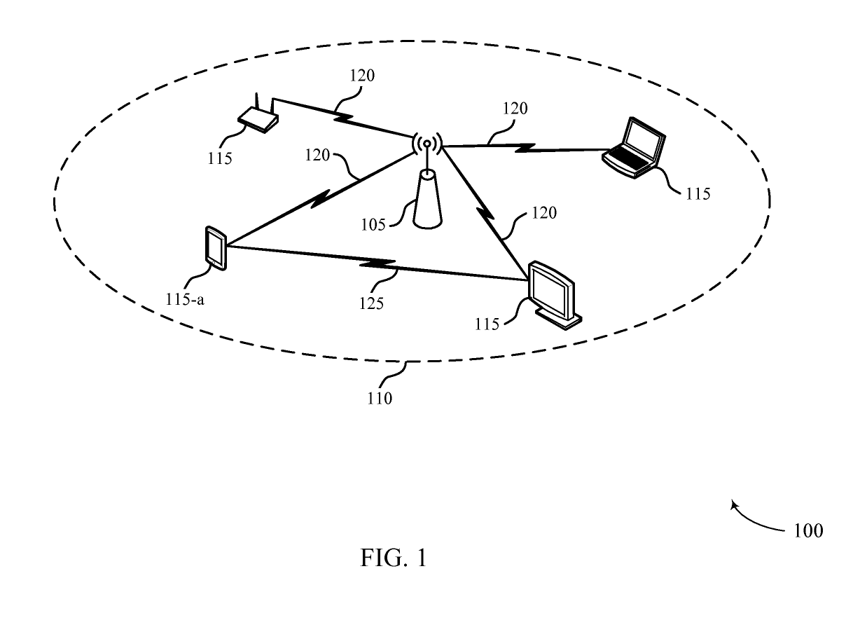

FIG. 1 illustrates a WLAN 100 (also known as a Wi-Fi network) configured in accordance with various aspects of the present disclosure. The WLAN 100 may include an AP 105 and multiple associated stations (STAs) 115, which may represent devices such as smartphones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network may be able to communicate with one another through the AP 105. Also shown is a geographic coverage area 110 of the AP 105, which may represent a basic service area (BSA) of the WLAN 100.

Although not shown in FIG. 1, a STA 115 may be located at the intersection of more than one geographic coverage area 110 and may associate with more than one AP 105. A single AP 105 and an associated set of STAs 115 may be referred to as a BSS. An ESS is a set of connected BSSs. A distribution system (DS) (not shown) may be used to connect APs 105 in an ESS. In some cases, the geographic coverage area 110 of an AP 105 may be divided into sectors (also not shown). The WLAN 100 may include APs 105 of different types (e.g., metropolitan area, home network, etc.), with varying and overlapping geographic coverage areas 110. Two STAs 115 may also communicate directly via a direct wireless link 125 regardless of whether both STAs 115 are in the same geographic coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, etc. In other implementations, peer-to-peer connections or ad hoc networks may be implemented within the WLAN 100.

In accordance with the present disclosure, a STA 115-a, for example, may be configured to perform SIFS burst transmission by transmitting multiple A-MPDUs without relinquishing control of the medium. However, while SIFS burst transmissions may improve throughput for the STA 115-a, such transmissions may negatively impact other STA(s) (e.g., STA 115-b) on the network. Conversely, increased reliance on SIFS burst transmissions by the STA 115-a may be desirable when the STA 115-a has a lot of data to transmit and traffic to and from the other STAs 115 in the BSS is light. As a result, either the AP 105 or the STA 115-a may actively monitor traffic on the network in order to dynamically adapt the SIFS burst parameters of one or more of the STAs 115 based at least in part on varying traffic conditions.

The traffic conditions may include measurements of airtime saturation and access fairness on the channel or in the BSS, including a measured or observed total amount of traffic over the channel or in the BSS, a measured or observed amount of traffic over the channel or in the BSS associated with a given access category, a measured or observed amount of traffic over the channel or in the BSS in a given direction, and similar measurements or observations. The traffic conditions may additionally or alternatively include parameters that indirectly convey information about airtime saturation and access fairness, such as a signal strength (e.g., RSSI) of the AP 105 or the STA 115-a, interference levels, a total number of STAs 115 communicating over the channel or in the BSS, a number of STAs 115 of a certain type or PHY rate communicating over the channel or in the BSS, a distribution of traffic over the channel or in the BSS among STAs 115 of different types of PHY rates, a number of active flows over the channel or in the BSS, a TCP window size of traffic transmitted over the channel or in the BSS, multi-user multiple input multiple output (MU-MIMO) parameters (e.g., MU-MIMO group size and total number of active flows) or similar parameters. In addition, the traffic conditions may include policy-based parameters, such as a type or classification (e.g., home network vs. guest network, home network vs. enterprise network, etc.) of a network associated with the traffic.

The AP 105 and/or STAs 115 may monitor the traffic conditions on the network in various ways. For example, the AP 105 and STAs 115 may examine their respective transmission and receive queues to identify parameters such as access category, throughput, direction, and the like in traffic that is being transmitted and received over the channel. In some examples, the AP 105 or STAs may perform deep packet inspection to identify the nature or type of traffic transmitted over the WLAN 100. Additionally, the AP 105 and STAs 115 may measure latency or throughput for on-going streams to identify congestion in the channel or BSS. The STAs 115 may also passively monitor on-going transmissions from other nodes and infer access category or traffic type information from the passively monitored transmissions. For example, a STA 115 may observe a series of periodic short transmissions by another STA 115 and infer that the transmissions are associated with VoIP traffic. Alternatively, access category information for passively observed transmissions may be inferred based on gaps between transmissions (e.g., shorter gaps between packets may indicate a lower-latency access class of traffic).

Using these and other monitoring techniques, the AP 105 and/or STAs 115 may detect changes in the traffic conditions on the network. These detected changes may result in adjustments to the SIFS burst parameters of the AP 105 and/or STAs 115. Other parameters, (e.g., enhanced distributed channel access (EDCA) parameters other than SIFS burst parameters) may also be adjusted in response to the detected changes. In certain examples, the AP 105 or a STA 115 may unilaterally monitor traffic conditions and trigger or request changes to the relevant parameters. Alternatively, the AP 105 and STAs 115 may exchange information to cooperatively identify changes in traffic conditions or update SIFS burst parameters.

The AP 105 may centrally coordinate the SIFS burst parameters used by STA 115 in the BSS. Accordingly, the STAs 115 may indicate their SIFS bursting capabilities and parameters to the AP 105 using, e.g., management frames. In response, the AP 105 may allocate SIFS burst parameters to be used by STAs 115 in BSS using, e.g., management messages or by using beacon signals. The allocation of SIFS burst parameters may be based at least in part on traffic conditions monitored by the AP 105 or the STAs. In certain examples, some of the parameters reported by the STAs 115 to the AP 105 may be indicative of the monitored traffic conditions, and may therefore influence the SIFS burst parameters. In some instances such as an overlapping BSS, an AP 105 may exchange the SIFS burst parameters used by a plurality of BSSs and determine a common SIFS burst parameter to be used by a plurality of overlapping BSSs.

As another possible check on burst transmissions, STAs 115 may request and receive permission from the AP 105 prior to using SIFS burst transmissions. Moreover, the STAs 115 may further request permission from the AP 105 prior to modifying SIFS burst parameters. Additionally, the AP 105 may instruct one or more STAs 115 to cease SIFS burst transmissions based at least in part on the monitored traffic conditions.

SIFS burst parameters may include one or more of: a permissible duration (or size) of A-MPDUs in an individual SIFS burst, a permissible number (or “SIFS burst count”) of A-MPDUs in an individual SIFS burst, a total duration (or size) of multiple SIFS burst transmissions, or other relevant parameters affecting the use of SIFS bursting by the STAs 115. In one example, size may be denoted by a number of bytes, bits, etc. Certain SIFS bursts may be multi-destination SIFS bursts that include packets addressed to different destinations. Accordingly, destination-specific SIFS burst parameters may also be adjusted based at least in part on the monitored traffic conditions. Examples of destination-specific SIFS burst parameters include a permissible duration (or size) of A-MPDU for a given destination, a permissible number of A-MPDUs per destination in a burst, a permissible total duration of A-MPDUs per destination, and other destination-specific SIFS burst parameters.

Upon detecting a change in one or more of the traffic conditions described above, the AP 105 may dynamically adapt one or more of these SIFS burst parameters to accommodate network traffic and increase network fairness among the STAs 115 in the BSS. For example, as the total amount of traffic over the channel or BSS increases (as indicated by the total number of STAs 115 accessing the channel or the BSS, the congestion of the channel, a throughput at the AP 105, the total number of active flows supported by the AP 105, or another metric), the individual or total SIFS burst size or SIFS burst count for one or more STAs 115 or the AP 105 may be decreased to allow for additional channel contention and transmission opportunities by underrepresented STAs 115. This reduction in SIFS burst size or SIFS burst count may reduce the occurrence of individual STAs 115 tying up the channel. Conversely, when the total amount of traffic over the channel or BSS decreases (as indicated by the total number of STAs 115 accessing the channel or the BSS, the total congestion of the channel or the BSS, the throughput at the AP 105, or the total number of flows supported by the AP 105), the individual or total SIFS burst size or SIFS burst count for one or more STAs 115 or the AP 105 may be increased to provide for more efficient channel usage and increased network throughput.

In some cases, the adjustment of SIFS burst parameters may be based at least in part on the access category of observed network traffic. The SIFS burst duration of a STA 115 may be inversely proportional to the amount of traffic of lower-latency access classes observed or anticipated on the channel from other STAs. For example, if an increase in latency sensitive traffic (e.g., VoIP traffic) from a first STA 115 is observed, the AP 105 may elect to reduce the SIFS burst size or SIFS burst count for a second STA 115 to allow the first STA 115 quicker access to the channel. Conversely, if an increase in traffic from the first STA 115 is mostly of a best effort access category, the AP 105 may determine not to modify the SIFS burst size or SIFS burst count for the second STA 115, or may even increase the SIFS burst size or SIFS burst count for the second STA 115.

The network traffic associated with the second STA 105-f may in some cases be transmitted without proper packet classification. For example, the network traffic may be latency sensitive traffic (e.g., VoIP) that may be misclassified or transmitted as a best effort access category. In such instances, either the AP 105 or STA 115 may infer an access category of the traffic based on deep packet inspection or observed traffic patterns, as discussed above. The SIFS burst parameters of the AP 105 or STA 115 may then be modified, or the SIFS bursting disabled or enabled, based at least in part on the inferred access category. In further examples, the AP 105 or STA 115 may adjust the SIFS burst parameters, TXOP, or other EDCA parameters for all access categories in order to accommodate the misclassified network traffic.

The direction of traffic on the channel may also affect the adjustment of SIFS burst parameters for one or more STAs 115. For example, the AP 105 may use a larger SIFS burst size or SIFS burst count for downlink traffic than is permitted for the STAs 115 to transmit uplink traffic. As such, a detected increase in traffic on the channel may result in different adjustments for downlink and uplink SIFS burst parameters (e.g., the SIFS burst size or SIFS burst count for the STAs 115 may be reduced more than the SIFS burst size or SIFS burst count for the AP 105).

The adjustment of SIFS burst parameters for one or more STAs 115 may be further based at least in part on changes in the PHY rate or class of STAs 115 communicating over the channel or connected to the BSS. The SIFS burst size or SIFS burst count for a STA 115 may be proportional to the PHY rate or class of other STAs accessing the channel or connected to the BSS. For example, if one or more legacy STAs 115 with a relatively low PHY rate join the BSS (e.g., lower than the PHY rates for the already connected STAs), the AP 105-c may increase the SIFS burst size or SIFS burst count for the legacy STAs 115 with respect to other STAs 115 having a higher PHY rate to increase overall fairness among the STAs 115. In other cases, the AP 105-c may decrease the SIFS burst size or SIFS burst count for the legacy STAs 115 with respect to the other STAs 115 to increase the overall throughput capacity of the network.

Another traffic condition which may affect the adjustment of SIFS burst parameters is the Transport Control Protocol (TCP) window size used in network traffic. For example, if traffic from at least one of the STAs 115 changes to use a larger TCP window size than a threshold value, the AP 105-c may increase the SIFS burst size or SIFS burst count for that STA 115. Similarly, if traffic from the STA 115 changes to use a smaller TCP window size than a threshold value, the AP 105-c may decrease the SIFS burst size or SIFS burst count for that STA 115.

Changes to the signal strength of one or more STAs 115 (as measured by the AP 105) or the AP 105 (as measured by one or more of the STAs 115) may also affect the adjustment of SIFS burst parameters. For example, a higher signal strength of a transmitting AP 105 or STA 115 (i.e., the RSSI of the transmitting AP 105 or STA 115 as measured by a receiving AP 105 or STA 115) may result in an increased SIFS burst size or SIFS burst count for the transmitting AP 105 or STA 115. Conversely, a weaker signal strength may result in a decreased SIFS burst size or SIFS burst count for the transmitting AP 105 or STA 115. In much the same way, a change in the amount of interference on the channel, as detected by the receiving AP 105 or STA 115, may result in a change to the SIFS burst size or SIFS burst count for the transmitting AP 105 or STA 115. For example, an increased amount of interference on the channel may cause the SIFS burst size or SIFS burst count of the transmitting AP 105 or STA 115 to be reduced, and a decrease in the amount of interference on the channel may cause the SIFS burst size or SIFS burst count of the transmitting AP 105 or STA 115 to be increased.

Changes in MU-MIMO parameters, such as MU-MIMO group size and a total number of active flows, may also affect the adjustment of SIFS burst parameters. For example, if there are three active flows at an AP 105, the AP may permit a larger SIFS burst size or SIFS burst count for a MU-MIMO transmission with a group size of three than a MU-MIMO transmission with a group size of two, as the group size of three may provide for better access to the channel by all three of the active flows.

In addition, the type or classification of a network associated with the traffic may affect SIFS bursting parameters. In some cases, the same AP 105 may provide access to both a home network and a guest network over the wireless channel. The AP 105 may set a shorter SIFS burst size or SIFS burst count for traffic from the guest network in comparison to traffic from the home network, or vice versa. In some cases, as changes in other traffic condition(s) are detected, the AP 105 may adjust SIFS bursting parameters differently (e.g., adjusting SIFS bursting parameters for only one of the networks or applying different degrees of adjustment to SIFS bursting parameters for the different networks in response to the detected change of the other traffic condition(s)).

The power save status of one or more STAs 115 served by the AP 105 may affect SIFS bursting parameters. STAs 115 in a power save mode may have different SIFS bursting parameters to allow the STAs to quickly exchange data with the AP 105 and return to sleep. Thus, when the AP 105 detects a change in the power save status of one or more STAs 115, the AP 105 may accordingly increase the SIFS burst size or SIFS burst count for STAs 115 entering the power save status and decrease the SIFS burst size or SIFS burst count for STAs 115 exiting the power save status.

In addition or alternatively to SIFS bursting parameters, other enhanced distributed channel access (EDCA) parameters may be adjusted in response to the changing traffic conditions to improve the quality of service associated with latency-sensitive traffic. The adjustment to these additional EDCA parameters may be in connection with or based at least in part on the adjustments made to the SIFS bursting parameters. Examples of these additional EDCA parameters include, but are not limited to, transmit opportunity (TXOP) durations, contention window boundaries or length, arbitration inter-frame spacing (AIFS) slots, and/or other enhanced distributed channel access (EDCA) parameters. For example, in one scenario, an AP 105 transmitting and receiving mostly traffic in a best effort access category may detect an increase in traffic associated with a low-latency best effort access category. In response to the detected increase in low-latency traffic, the AP 105 may increase a TXOP duration associated with the low-latency access category and/or reduce a TXOP duration associated with the best effort access category. Additionally or alternatively, the AP 105 may decrease the backoff (e.g., increase the contention window) for the low-latency traffic and increase the backoff (e.g., decrease the contention window) for the best effort access category. These adjustments may be specific to individual STAs 115 or groups of STAs 115 or globally implemented among all STAs 115 connected to the AP 105.

In addition to adjusting SIFS bursting and other EDCA parameters, the AP 105 and STAs may take other measures to increase the QoS of latency-sensitive traffic in response to detected change in traffic conditions. For example, AP 105 may use a reverse direction grant (RDG) frame to request pending uplink traffic from the STA 115, thereby reducing the latency for high-priority uplink traffic from a STA 115. On the STA 115 side, the STA 115 may use an unscheduled automatic power save deliver (U-APSD) to poll the AP 105 for pending traffic if the STA is expecting high-priority or low-latency downlink traffic. Additionally or alternatively, an AP 105 or STA 115 that is transmitting a SIFS burst associated with a best effort access class may preempt (e.g., prematurely terminate) when MSDUs associated with a low-latency access class are received from higher layers. This preemption of the SIFS burst may allow the STA 115 to transmit the low-latency MSDUs faster, thereby providing a better quality of service.

The foregoing paragraphs have described various ways by which an AP 105 or STA 115 may detect changes in traffic conditions and take actions to improve the quality-of-service of high-priority or low-latency traffic. To illustrate the application of these principles, the following example discusses how an AP 105 and STA 115 of a WLAN 100 may improve the quality-of-service of traffic associated with a VoIP call. In this example, the STA 115 may use the WLAN 100 to transmit uplink VoIP packets for the call to a third-party VoIP service (not shown) and receive downlink VoIP packets for the call from the third-party VoIP service. The third-party VoIP service may not support the use of a low-latency voice access class (e.g., AC_VO), and instead cause all traffic to be associated with a default best effort access class (e.g., AC_BE). The STA 115 may use deep packet inspection, observed traffic patterns, or other techniques to identify the presence of VoIP traffic. For example, VoIP traffic may be inferred by looking at parameters such as the number of uplink and downlink packets associated with a socket, the periodicity of packets associated with a socket, packet arrival patterns, and other factors.

Upon determining that a particular socket or connection is associated with VoIP traffic, the STA 115 may request the AP 105 to change SIFS bursting and other EDCA parameters to improve the VoIP latency in the downlink and uplink directions. For example, the AP 105 may request a longer SIFS burst duration for one or both of the STA 115 and the AP 105 while the VoIP socket remains active. The STA 115 may also dynamically change the access class for packets transmitted from that socket to the low-latency voice access class. This adjustment to the access class may improve the VoIP latency over the uplink. The STA 115 improve the VoIP latency for the downlink by transmitting a U-APSD frame requesting the AP 105 to provide any pending packets for the VoIP socket in the downlink. Thus, even if the VoIP service transmits downlink packets to the STA 115 using the best effort access category, the STA 115 can still expedite the delivery of the downlink VoIP packets by proactively polling the AP 105 for the packets. The STA 115 may also transmit a request to the AP 105 to send all downlink packets for the VoIP socket using the lower-latency voice access class.

Additionally or alternatively, the AP 105 may take actions to improve the quality-of-service of traffic associated with a VoIP call. The AP 105 may use deep packet inspection, observed traffic patterns, or other techniques to detect VoIP packets transmitted between the STA 115 and the third-party VoIP service. In response to this change in traffic conditions, the AP 105 may proactively change SIFS bursting parameters or other EDCA parameters to improve the VoIP latency in the downlink and uplink directions. As noted above, the SIFS burst duration for one or both of the STA 115 and the AP 105 may be increased while the VoIP call remains active. In addition, the AP 105 may dynamically change the access class for identified VoIP packets from the best effort access class to the low-latency voice access class. The AP 105 may periodically transmit a RDG frame to the STA to request any pending uplink, thereby increasing the speed with which uplink VoIP packets are forwarded to the VoIP service. The AP 105 may also transmit a request to STA 115 to send all uplink packets to the AP 105 using the low-latency voice access class.

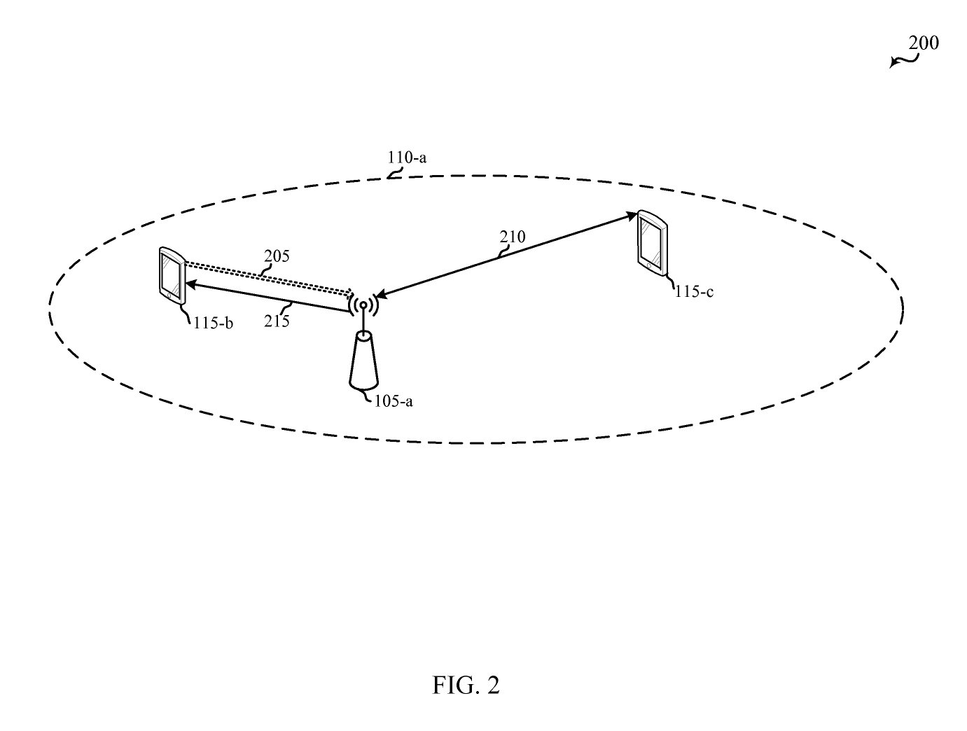

FIG. 2 illustrates an example of a wireless communications subsystem 200 for adaptive SIFS bursting in accordance with various aspects of the present disclosure. Wireless communications subsystem 200 may include STAs 115-b and 115-c, which may each be examples of a STA 115 described above with reference to FIG. 1. Wireless communications subsystem 200 may also include an AP 105-a, which may be an example of an AP 105 described above with reference to FIG. 1.

In accordance with the present disclosure, the SIFS burst parameters associated with the wireless devices (i.e., AP 105-a or STAs 115) may be adapted to improve network performance. SIFS burst parameters may be modified based at least in part on traffic flow in the network. For example, a first STA 115-b may occupy a transmission channel to perform SIFS burst transmissions 205 of a best effort or higher-latency access class to the AP 105-a using a first set of SIFS burst parameters defining the permissible individual or total SIFS burst duration or length. However, when the AP 105-a detects that a second STA 115-c begins to transmit latency sensitive traffic 210 (e.g., VoIP data frames) on the network, the AP 105-a may reduce the individual or total SIFS burst duration or length of the STA 115-a to provide better access to channel by the second STA 115-c.

Therefore, the AP 105-a and/or the STA 115-b may actively monitor traffic conditions on the network and dynamically modify SIFS parameters associated with STA 115-b to accommodate other traffic on the network. In one or more examples, the AP 105-a may instruct the STA 115-b to modify the SIFS burst parameter 215 based at least in part on the monitored traffic conditions. SIFS burst parameters may be assigned based at least in part on an access category of the traffic (e.g., best effort, background, voice or video). In other examples, SIFS burst parameters may be set differently for the downlink traffic compared to the uplink traffic. For example, the AP 105-a may use a longer SIFS burst duration compared to the SIFS burst duration for STA 115-b. Such variations may enable the AP 105-a to control and tune the total bandwidth provided for downlink and uplink traffic. In yet further examples, the SIFS burst parameters may be adjusted based at least in part on a PHY rate of the device to burst. For example, lower PHY rate STAs 115 may be allocated longer SIFS burst durations compared to higher PHY rate STAs 115 to allow fairness between different types of STAs 115. Alternatively, lower PHY rate STAs 115 may be provided with shorter SIFS burst durations to improve the overall capacity of the network.

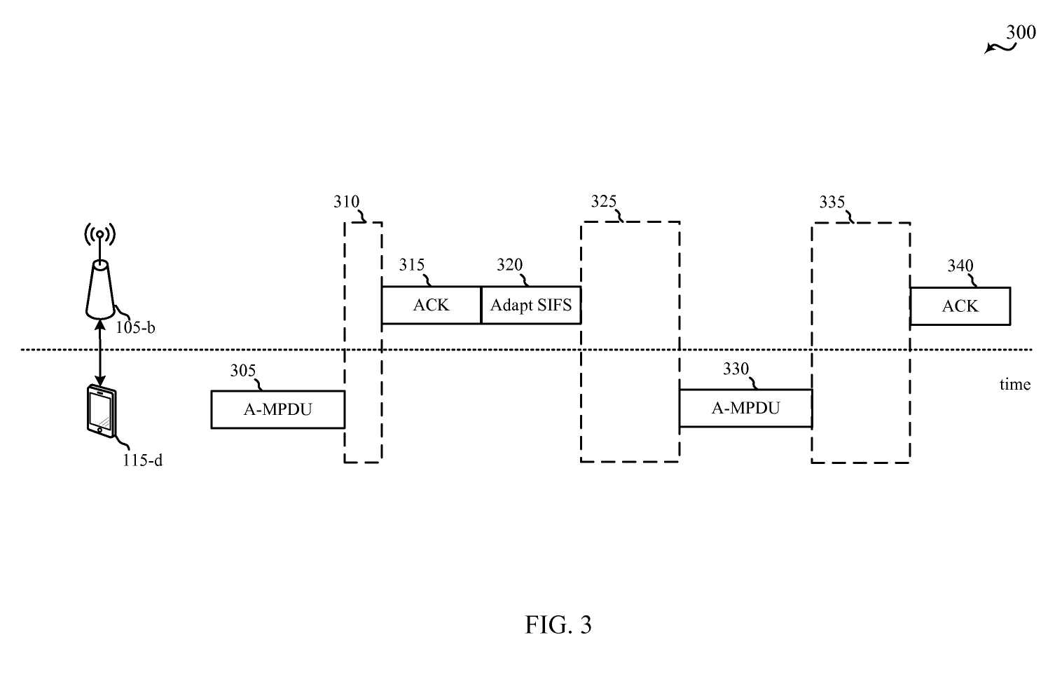

FIG. 3 illustrates an example of a communication diagram 300 for adaptive SIFS bursting in accordance with various aspects. The communication diagram 300 may include a STA 115-d, which may be an example of a STA 115 described above with reference to FIGS. 1-2. The communication diagram 300 may also include an AP 105-b, which may be an example of an AP 105 described above with reference to FIGS. 1-2.

The STA 115-d may begin a SIFS burst by transmitting a first A-MPDU frame 305 to the AP 105-b. The AP, following a first short inter-frame space (SIFS) 310 period, may transmit an ACK frame 315 that acknowledges the receipt of the first A-MPDU frame 305. However, during such time period, the AP 105-b may detect variation in the traffic conditions on the network. As a result, the AP 105-b may determine to modify the SIFS parameter associated with STA 115-d by transmitting an adapt SIFS management message 320 to the STA 115-d. The adapt SIFS management message 320 may instruct the STA 115-d to increase the time duration associated with SIFS to accommodate network traffic. As a result, the STA 115-d may modify the SIFS parameters to extend the SIFS duration, and wait a second (extended) SIFS 325 period prior to transmitting a second A-MPDU frame 330 to the AP 105-b. Based at least in part on the modified SIFS parameters, the AP 105-b may wait for designated time interval associated with a third (extended) SIFS 335 period prior to transmitting an ACK frame 340 to the STA 115-d that acknowledges the receipt of the second A-MPDU frame 330.

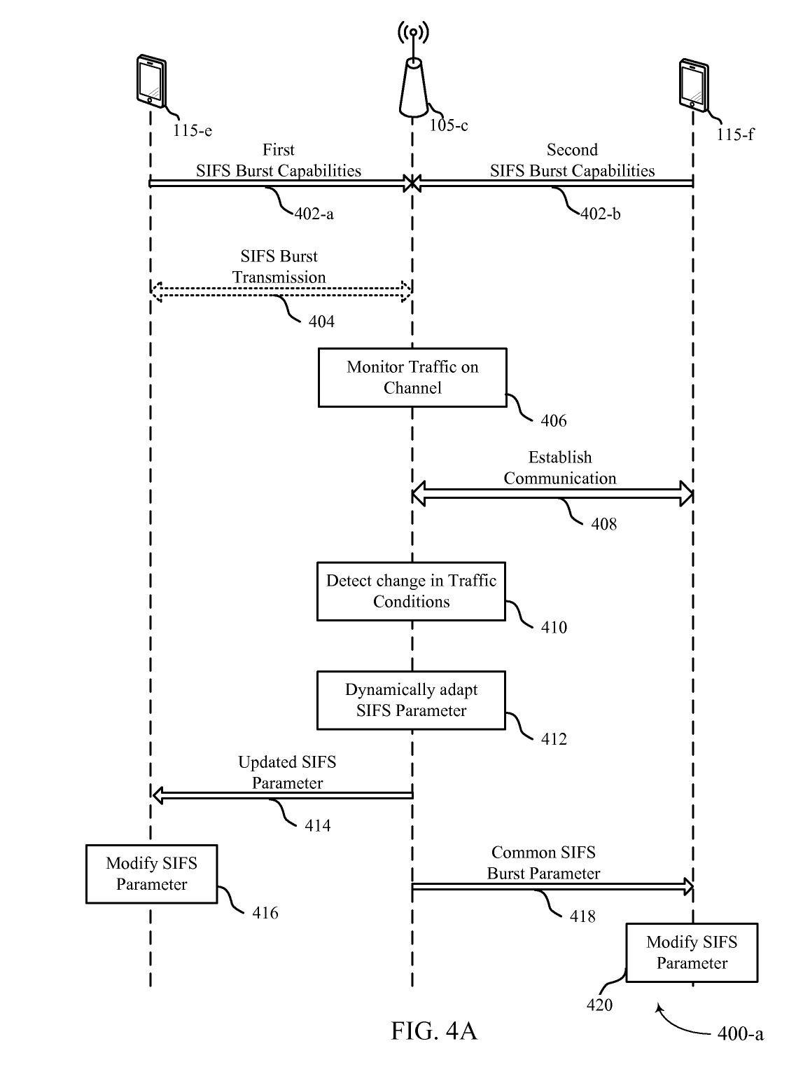

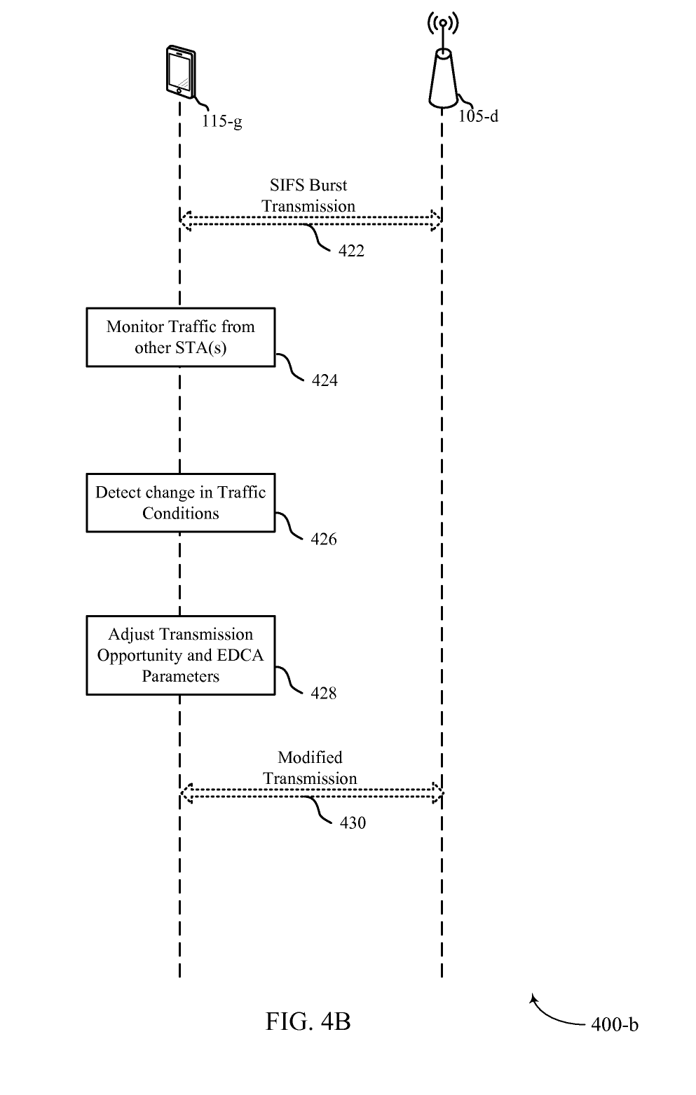

FIG. 4A illustrates an example of communication between an AP 105-c and STAs 115-e for adaptive SIFS bursting in accordance with various aspects of the present disclosure. The STAs 115-e and 115-f may each be an example of a STA 115 described above with reference to FIGS. 1-3. The AP 105-c may be an example of an AP 105 described above with reference to FIGS. 1-2.

The first STA 115-e and second STA 115-f may transmit first SIFS burst capabilities 402-a and second SIFS burst capabilities 402-b respectively to the AP 105-c. The SIFS burst capabilities may include information to identify if the STA 115 is capable of (and in some embodiments, configured to support) SIFS burst transmission. For example, some legacy STAs 115 may not be capable of supporting SIFS burst transmission. In one example, the AP 105-c and the associated STAs 115 may represent a basic service set (BSS) or an extended service set (ESS). The first STA 115-e may then perform a SIFS burst transmission 404. In some embodiments, in order to maintain network fairness, the AP 105-c may actively monitor traffic on the channel (e.g., the wireless medium) associated with the BSS at block 406. The AP 105-c may monitor the access categories of on-going flows (e.g., using transmit (Tx) or receive (Rx) queues) and use the monitored access category as a basis for modifying one or more SIFS burst parameters associated with the STAs 115 or the AP 105. In other examples, the AP 105-c may monitor the latency and throughput for the on-going traffic and trigger adjustments to SIFS burst parameters of the STAs 115 or the AP 105 based at least in part on the measured latency.

During the active traffic monitoring, a second STA 115-f may establish communication 408 with the AP 105-c. At block 410, the AP 105-c may detect a change in traffic conditions based at least in part on the established communication 408 with the second STA 115-f.

Upon detecting a change in the traffic conditions, the AP 105-c may determine, at block 412, whether to dynamically adapt one or more SIFS parameter(s) to accommodate the network traffic and increase network fairness among the STAs 115 in the BSS. The adjustment to the SIFS parameter(s) may be in accordance with the principles discussed above with respect to FIG. 1. The determination to adapt the SIFS parameter(s) may be, for example, in response to a threshold change in an observed traffic conditions metric (e.g., airtime saturation, access fairness, access category, traffic throughput, traffic direction, signal strength, interference, number of STAs in the BSS, type of STAs in the BSS, PHY rate of STAs in the BSS, distribution of traffic to different types of STAs, number of active flows, TCP window size, etc.). The threshold amount may be specific to the parameter monitored, and defined at the AP 105.

Accordingly, at block 412, the AP 105-c may determine to dynamically adapt a SIFS parameter to accommodate the detected change in monitored network traffic. The AP 105-c may modify the SIFS parameter of the STA 115-e by transmitting a modify SIFS parameter frame 414 to the STA 115-e. Upon receiving the modify SIFS parameter frame 414, the STA 115-e may update at least one or more its SIFS parameters at block 416. As discussed above, the SIFS parameter may include a permissible A-MPDU duration or size, a permissible number of A-MPDUs in a SIFS burst, a permissible total burst duration, a TXOP duration for one or more of the STAs 115, an EDCA parameter for network traffic, or another parameter.

The AP 105-c may also determine a common SIFS burst parameter 418 for a plurality of STAs 115 in the BSS based at least in part on the monitored network traffic. In such instance, the AP 105-c may transmit the common SIFS burst parameter 418 to each STA 115, and thus request the plurality of STAs 115 in the BSS to modify the SIFS burst parameters at block 420.

FIG. 4B illustrates another example of communications between an AP 105-d and a STA 115-g for adaptive short inter-frame space bursting in accordance with various aspects of the present disclosure. The STA 115-g may be an example of a STA 115 described above with reference to FIGS. 1-4A, and the AP 105-d may be an example of an AP 105 described above with reference to FIGS. 1-4A.

As discussed above, STAs 115 may also monitor the active traffic conditions on the network and modify their own SIFS parameters based at least in part on the detected traffic. For example, STA 115-f may perform a SIFS burst transmission 422 with AP 105-d. However, during the burst transmission, the STA 115-g may be cognitive of other STA(s) on the network. As a result, the STA 115-g, at block 424, may monitor on-going transmissions from other STA(s). STA 115-g, at block 426, may detect a change in traffic conditions on at least one traffic channel. As previously discussed, the detected change in traffic condition may be a change in access categories associated with traffic transmitted over the channel or in the BSS, a change in the amount of uplink or downlink traffic transmitted over the channel or in the BSS, a change in the type or PHY rate of STAs 115 in the BSS, a change in the total number of STAs in the BSS, a change in the number of active flows transmitted over the channel or in the BSS, or a change in the TCP window size associated with traffic transmitted over the channel or in the BSS, or other types of detectable changes in the monitored traffic.

In some cases, the STA 115-g may notify the AP 105-d of the detected change in traffic conditions so that the AP 105-d may modify the SIFS burst parameters for the plurality of STAs 115 associated with the BSS. Upon detecting the change in traffic conditions, the STA 115-g, at block 428, may adjust one or more of its own SIFS parameters. The adjustment may be similar to the adjustments described in the examples of FIG. 4A. In some cases, the SIFS parameters adjusted by the STA 115-g may include the permissible duration of the A-MPDU, the permissible number of A-MPDUs in a SIFS burst, or the permissible total duration of the burst, a TXOP duration, or an EDCA parameter for network traffic. Thus, based at least in part on the modified SIFS parameters, the STA 115-g may communicate 430 with the AP 105-d.

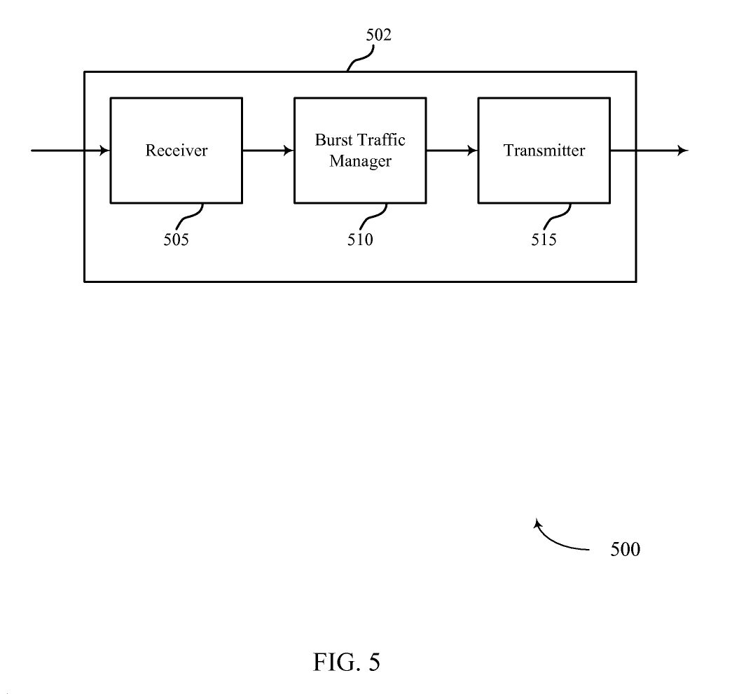

FIG. 5 shows a block diagram 500 of a wireless device 502 configured for adaptive short inter-frame space bursting in accordance with various aspects of the present disclosure. The wireless device 502 may be an example of aspects of a STA 115 or AP 105 described with reference to FIGS. 1-4. Wireless device 502 may include a receiver 505, a burst traffic manager 510, or a transmitter 515. Wireless device 502 may also include a processor. Each of these components may be in communication with each other.

The components of wireless device 502 may, individually or collectively, be implemented with at least one application specific integrated circuit (ASIC) adapted to perform some or all of the applicable functions in hardware. Alternatively, the functions may be performed by one or more other processing units (or cores), on at least one IC. Other types of integrated circuits may also be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors. For example, the receiver 505 may be a hardware receiver, the transmitter 515 may be a hardware transmitter, and the burst traffic manager 510 may be a processor and memory to process and store, respectively, the computer readable medium embodying the actions to be taken by the device to manage the burst traffic.

The receiver 505 may receive information such as packets, user data, or control information associated with various information channels (e.g., control channels, data channels, and information related to adaptive short inter-frame space bursting, etc.). Information may be passed on to the burst traffic manager 510, and to other components of wireless device 502.

The burst traffic manager 510 may monitor traffic information on a channel, identify a change in the monitored traffic information, and adapt a SIFS burst parameter based at least in part on the change in the monitored traffic information.

The transmitter 515 may transmit signals received from other components of wireless device 502. The transmitter 515 may be collocated with the receiver 505 in a transceiver module. The transmitter 515 may include a single antenna, or it may include a plurality of antennas. The transmitter 515 may transmit the adapted SIFS burst parameter from a first wireless device to a second wireless device, wherein one of the wireless devices is an access point (AP) and the other of the wireless devices is a station. The transmitter 515 may the adapted SIFS burst parameter is transmitted to the second wireless device using a message from the group consisting of: a management message and a beacon signal. The transmitter 515 may transmit the common SIFS burst parameter to the plurality of wireless devices.

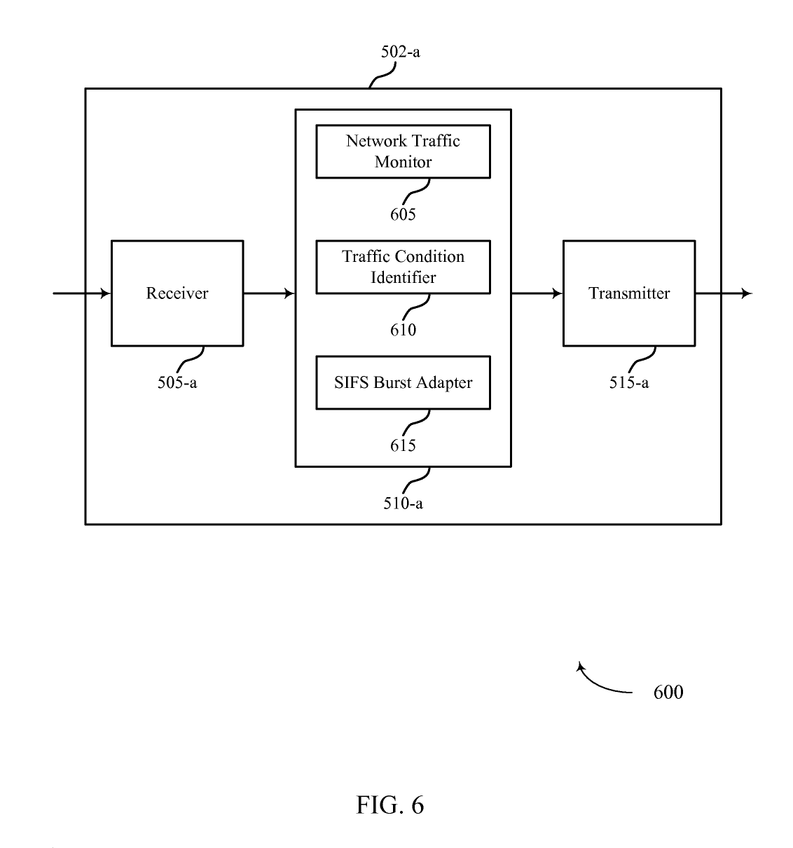

FIG. 6 shows a block diagram 600 of a wireless device 502-a for adaptive SIFS bursting in accordance with various aspects of the present disclosure. The wireless device 502-a may be an example of aspects of the wireless device 502 described with reference to FIG. 5. The wireless device 502-a may be an example of aspects of a STA 115 or AP 105 described with reference to FIGS. 1-4. The wireless device 502-a may include a receiver 505-a, a burst traffic manager 510-a, or a transmitter 515-a. The wireless device 502-a may also include a processor. Each of these components may be in communication with each other. The burst traffic manager 510-a may also include a network traffic monitor 605, a traffic condition identifier 610, and a SIFS burst adapter 615.

The components of wireless device 502-a may, individually or collectively, be implemented with at least one ASIC adapted to perform some or all of the applicable functions in hardware. Alternatively, the functions may be performed by one or more other processing units (or cores), on at least one IC. Other types of integrated circuits may also be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 505-a may receive information which may be passed on to the burst traffic manager 510-a, and to other components of wireless device 502-a. The burst traffic manager 510-a may perform the operations described above with reference to FIG. 5. The transmitter 515-a may transmit signals received from other components of wireless device 502-a.

The network traffic monitor 605 may monitor traffic information on a channel as described above with reference to FIGS. 2-4. The monitored traffic information may be selected from the group consisting of an access category, a link direction, a number of stations in the BSS, a number of active flows in BSS, traffic flow information, and a QoS requirement.

The traffic condition identifier 610 may identify a change in the monitored traffic information as described above with reference to FIGS. 2-4.

The SIFS burst adapter 615 may adapt a SIFS burst parameter based at least in part on the change in the monitored traffic information as described above with reference to FIGS. 2-4. The SIFS burst parameter may be selected from the group consisting of a duration of an aggregate media access control protocol data unit (A-MPDU), number of A-MPDUs in a burst, a total duration of the burst, and an available bandwidth. The SIFS burst parameter comprises a destination-specific SIFS burst parameter.

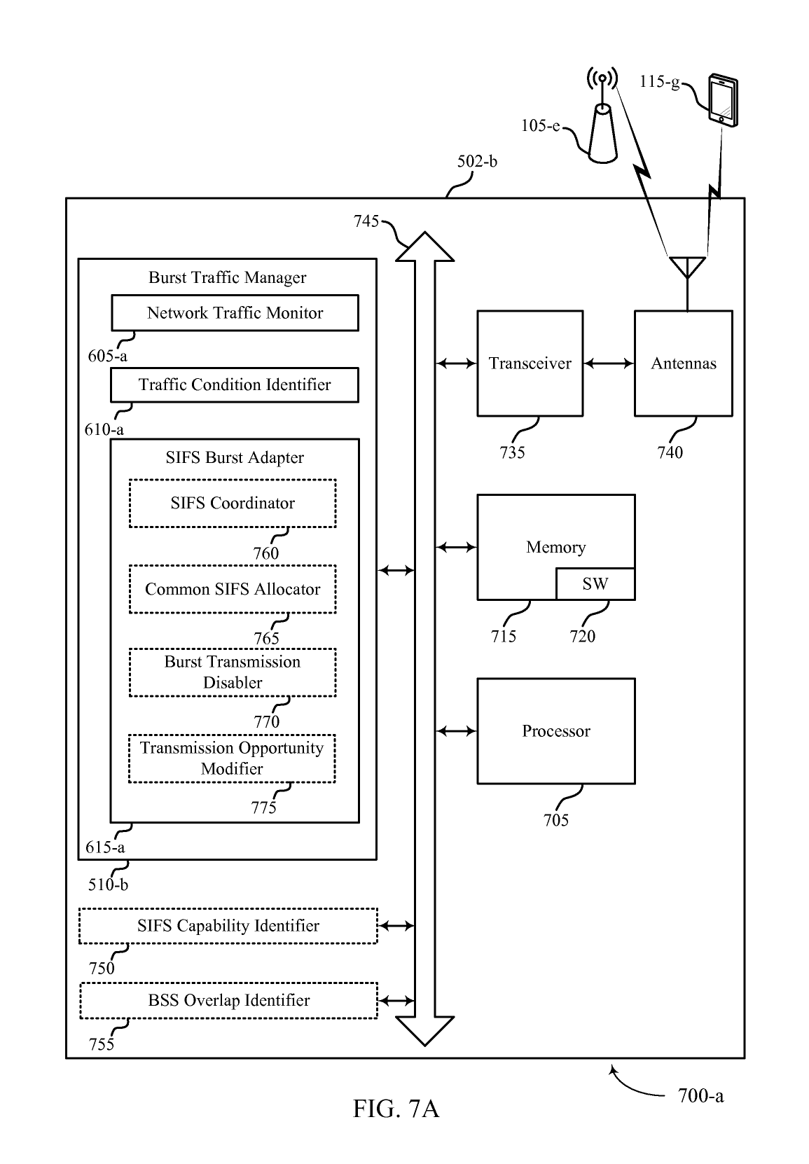

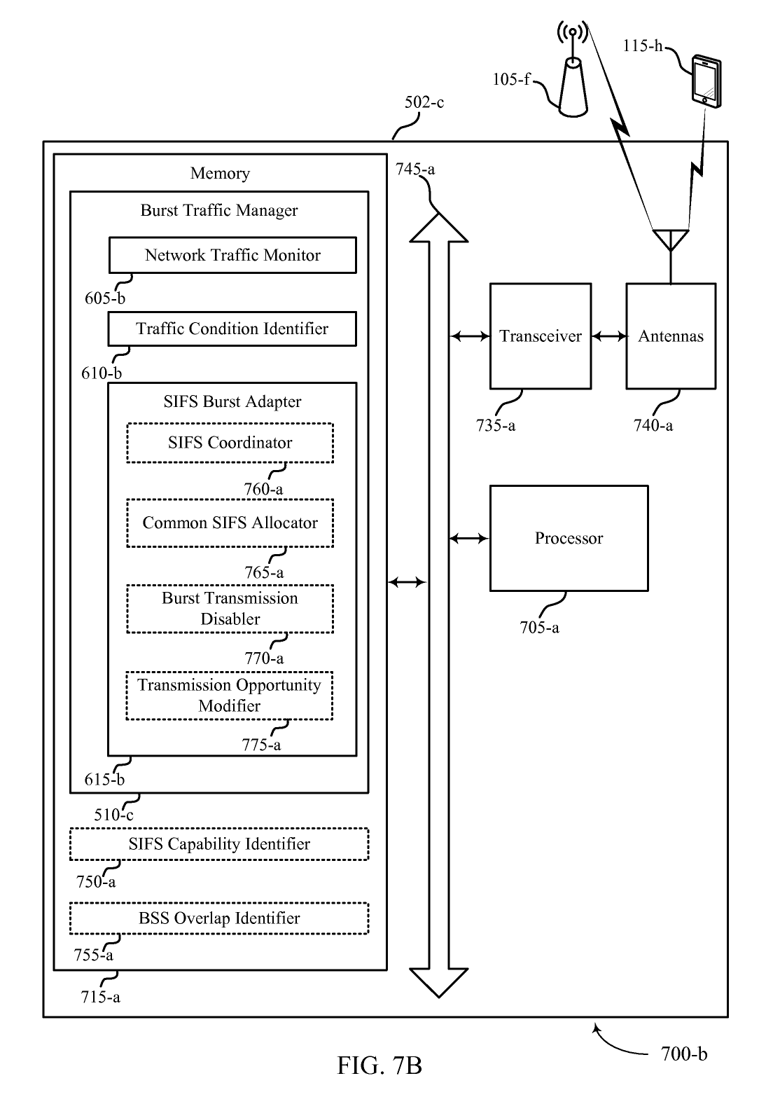

FIG. 7A shows a diagram of a system 700-a including a wireless device 502-b configured for adaptive short inter-frame space bursting in accordance with various aspects of the present disclosure. The system 700-a may include a wireless device 502-b, which may be an example of a STA 115 or AP 105 described above with reference to FIGS. 1-6. The wireless device 502-b may include a burst traffic manager 510-b, a SIFS capability identifier 750, and a BSS overlap identifier 755. The burst traffic manager 510-b may be an example of the burst traffic manager described in FIGS. 5-6, and may include a network traffic monitor 605-a, a traffic condition identifier 610-a, and a SIFS burst adapter 615-a, which may be examples of the network traffic monitor 605, traffic condition identifier 610, and SIFS burst adapter 610 described with reference to FIG. 6. The wireless device 502-b may also include components for bi-directional voice and data communications including components for transmitting communications and components for receiving communications. For example, wireless device 502-b may communicate bi-directionally with STA 115-h or AP 105-e.

The wireless device 502-b may include a processor 705, and memory 715 (storing software (SW)) 720, a transceiver 735, and one or more antenna(s) 740, each of which may communicate, directly or indirectly, with one another (e.g., via buses 745). The transceiver 735 may communicate bi-directionally, via the antenna(s) 740 or wired or wireless links, with one or more networks, as described above. For example, the transceiver 735 may communicate bi-directionally with an AP 105 or another STA 115. The transceiver 735 may include a modem to modulate the packets and provide the modulated packets to the antenna(s) 740 for transmission, and to demodulate packets received from the antenna(s) 740. While the wireless device 502-b may include a single antenna 740, the wireless device 502-b may also have multiple antennas 740 capable of concurrently transmitting or receiving multiple wireless transmissions.

The memory 715 may include random access memory (RAM) and read only memory (ROM). The memory 715 may store computer-readable, computer-executable software/firmware code 720 including instructions that, when executed, cause the processor 705 to perform various functions described herein (e.g., adaptive short inter-frame space bursting, etc.). Alternatively, the computer-executable software/firmware code 720 may not be directly executable by the processor 705 but cause a computer (e.g., when compiled and executed) to perform functions described herein. The processor 705 may include an intelligent hardware device, (e.g., a central processing unit (CPU), a microcontroller, an ASIC, etc.).

The network traffic monitor 605-a, traffic condition identifier 610-a, and SIFS burst adapter 615-a may perform the functions described above with reference to FIG. 6. The SIFS burst adapter 615-a may include a SIFS coordinator 760, a common SIFS allocator 765, a burst transmission disabler 770, and a transmission opportunity modifier 775.

The network traffic monitor 605-a, traffic condition identifier 610-a, SIFS burst adapter 615-a, SIFS capability identifier 750, and BSS overlap identifier 755 may, individually or collectively, be implemented with at least one ASIC adapted to perform some or all of the applicable functions in hardware. Alternatively, the functions of these components may be performed by one or more other processing units (or cores), on at least one IC. Other types of integrated circuits may also be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The SIFS capability identifier 750 may receive a message indicating SIFS bursting capabilities of the second wireless device; wherein the SIFS burst parameter is based at least in part on the SIFS bursting capabilities of the second wireless device as described above with reference to FIGS. 2-4.

The BSS overlap identifier 755 may identify, at a first wireless device of a first BSS, a second BSS that overlaps with the first BSS as described above with reference to FIGS. 2-4. Additionally or alternatively, the SIFS coordinator 760 may communicate with a second wireless device of the second BSS to coordinate the SIFS burst parameter as described above with reference to FIGS. 2-4. The common SIFS allocator 765 may determine a common SIFS burst parameter to be used by a plurality of wireless devices in the first BSS and the second BSS as described above with reference to FIGS. 2-4.

The burst transmission disabler 770 may disable SIFS burst transmissions based at least in part on the identified change in the monitored traffic information as described above with reference to FIGS. 2-4. The transmission opportunity modifier 775 may adjust a transmission opportunity (TXOP) duration or enhanced distributed channel access (EDCA) parameter based at least in part on the change in the monitored traffic information as described above with reference to FIGS. 2-4.

FIG. 7B shows a diagram of a system 700-b including a wireless device 502-c configured for adaptive short inter-frame space bursting in accordance with various aspects of the present disclosure. The system 700-b may include a wireless device 502-c, which may be an example of a STA 115 or AP 105 described above with reference to FIGS. 1-6. Similar to the wireless device 502-b of FIG. 7A, the wireless device 502-c of FIG. 7B may include a burst traffic manager 510-c, a SIFS capability identifier 750-a, and a BSS overlap identifier 755-a, which may perform the functions of the corresponding components in FIG. 7A. The wireless device 502-c may also include components for bi-directional voice and data communications including components for transmitting communications and components for receiving communications. For example, the wireless device 502-c may communicate bi-directionally with STA 115-i or AP 105-f.

The wireless device 502-c may include a processor 705-a, and memory 715-a (storing software (SW)), a transceiver 735-a, and one or more antenna(s) 740-a, each of which may communicate, directly or indirectly, with one another (e.g., via buses 745-a). The transceiver 735-a may communicate bi-directionally, via the antenna(s) 740-a or wired or wireless links, with one or more networks, as described above. For example, the transceiver 735-a may communicate bi-directionally with an AP 105 or another STA 115. The transceiver 735-a may include a modem to modulate the packets and provide the modulated packets to the antenna(s) 740-a for transmission, and to demodulate packets received from the antenna(s) 740. While the wireless device 502-c may include a single antenna 740-a, the wireless device 502-c may also have multiple antennas 740-a capable of concurrently transmitting or receiving multiple wireless transmissions.

The memory 715-a may include random access memory (RAM) and read only memory (ROM). The memory 715-a may store computer-readable, computer-executable software/firmware code including instructions that, when executed, cause the processor 705 to perform various functions described herein (e.g., adaptive short inter-frame space bursting, etc.). Alternatively, the software/firmware code may not be directly executable by the processor 705-a but cause a computer (e.g., when compiled and executed) to perform functions described herein. The processor 705-a may include an intelligent hardware device, (e.g., a central processing unit (CPU), a microcontroller, an ASIC, etc.). In the example of FIG. 7B, the network traffic monitor 605-a, traffic condition identifier 610-a, SIFS burst adapter 615-a, SIFS capability identifier 750-a, and BSS overlap identifier 755-a may be implemented as software/firmware code executable by the processor 705.

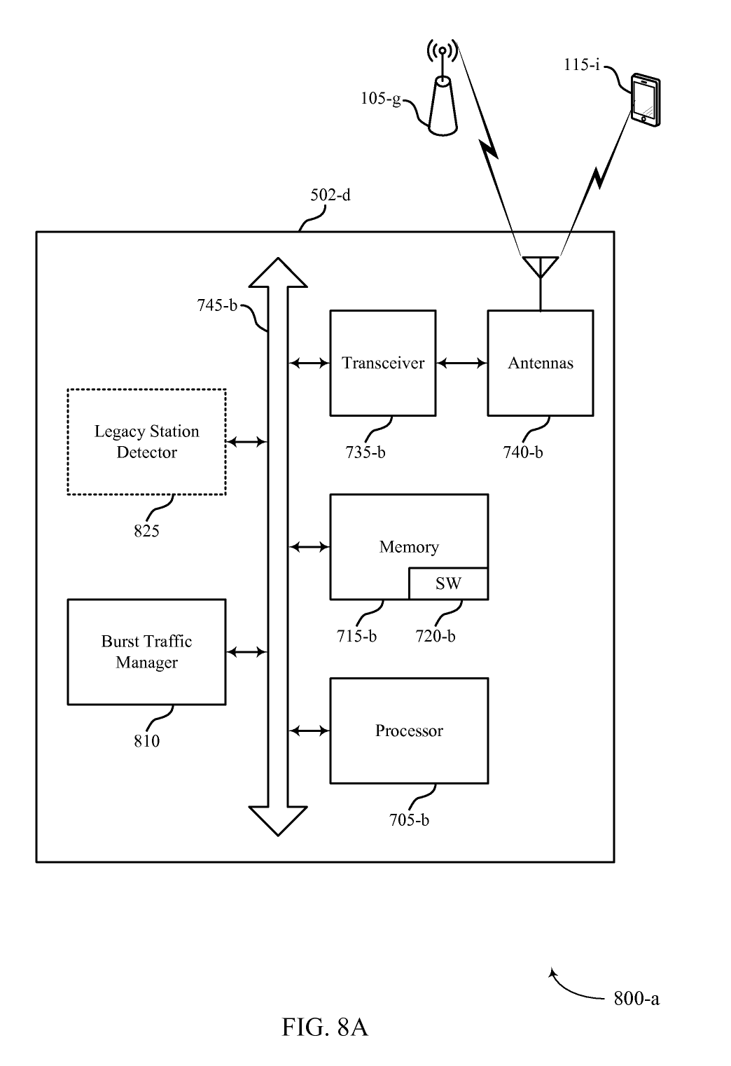

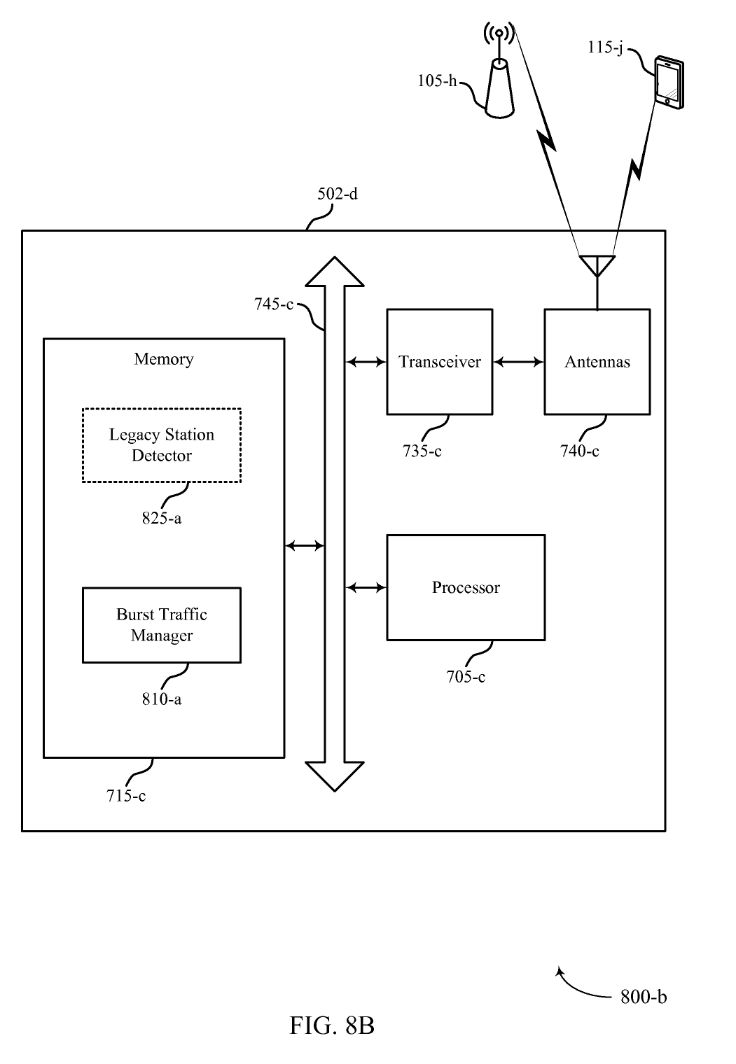

FIG. 8A shows a diagram of a system 800-a including a wireless device 502-d configured for adaptive short inter-frame space bursting in accordance with various aspects of the present disclosure. The wireless device 502-d may be an example of a STA 115 or AP 105 described above with reference to FIGS. 1-7B. The wireless device 502-d may include a burst traffic manager 810, which may be an example of a burst traffic manager 510 described with reference to FIGS. 5-7. The wireless device 502-d may also include a legacy station detector 825. The wireless device 502-d may also include components for bi-directional voice and data communications including components for transmitting communications and components for receiving communications. For example, the wireless device 502-d may communicate bi-directionally with STA 115-j or AP 105-g.

The wireless device 502-d may also include a processor 705-b, and memory 715-b (storing software (SW)) 720-a, a transceiver 735-b, and one or more antenna(s) 740-b, each of which may communicate, directly or indirectly, with one another (e.g., via buses 745-b). The transceiver 735-b may communicate bi-directionally, via the antenna(s) 740-b or wired or wireless links, with one or more networks, as described above. For example, the transceiver 735-b may communicate bi-directionally with an AP 105 or another STA 115. The transceiver 735-b may include a modem to modulate the packets and provide the modulated packets to the antenna(s) 740-b for transmission, and to demodulate packets received from the antenna(s) 740-b. While wireless device 502-d may include a single antenna 740-b, wireless device 502-d may also have multiple antennas 740-b capable of concurrently transmitting or receiving multiple wireless transmissions. The legacy station detector 825 may detect at least one legacy station as described above with reference to FIGS. 2-4. A wireless device using long SIFS burst duration may unduly impact the performance of legacy STAs that may not use SIFS bursting. As a result, legacy station detector 825 may identify a legacy station by explicit messaging or by observing their activity on the network. The SIFS burst parameters may be adapted or adjusted based at least in part on the presence of legacy STAs in the network (e.g., short SIFS burst duration if legacy STAs are present and have active traffic.

The memory 715-b may include random access memory (RAM) and read-only memory (ROM). The memory 715-b may store computer-readable, computer-executable software/firmware code 720-a including instructions that, when executed, cause the processor 705-b to perform various functions described herein (e.g., adaptive short inter-frame space bursting, etc.). Alternatively, the computer-executable software/firmware code 720-a may not be directly executable by the processor 705-b but cause a computer (e.g., when compiled and executed) to perform functions described herein. The processor 705-b may include an intelligent hardware device, (e.g., a central processing unit (CPU), a microcontroller, an ASIC, etc.)

FIG. 8B shows a diagram of a system 800-b including a wireless device 502-e configured for adaptive short inter-frame space bursting in accordance with various aspects of the present disclosure. The wireless device 502-e may be an example of a STA 115 or AP 105 described above with reference to FIGS. 1-8A. The wireless device 502-e may include a burst traffic manager 810-a, which may be an example of a burst traffic manager 510 described with reference to FIGS. 5-7. The wireless device 502-e may also include a legacy station detector 825-a. The wireless device 502-e may also include components for bi-directional voice and data communications including components for transmitting communications and components for receiving communications. For example, the wireless device 502-e may communicate bi-directionally with STA 115-k or AP 105-h.

The wireless device 502-e may also include a processor 705-c, memory 715-c (storing software (SW)), a transceiver 735-c, and one or more antenna(s) 740-c, each of which may communicate, directly or indirectly, with one another (e.g., via buses 745-c). The transceiver 735-c may communicate bi-directionally, via the antenna(s) 740-c or wired or wireless links, with one or more networks, as described above. For example, the transceiver 735-c may communicate bi-directionally with an AP 105 or another STA 115. The transceiver 735-c may include a modem to modulate the packets and provide the modulated packets to the antenna(s) 740-c for transmission, and to demodulate packets received from the antenna(s) 740-c. While the wireless device 502-e may include a single antenna 740-c, the wireless device 502-e may also have multiple antennas 740-c capable of concurrently transmitting or receiving multiple wireless transmissions. The legacy station detector 825-a may perform the functions described in FIG. 8A.

The memory 715-c may include random access memory (RAM) and read-only memory (ROM). The memory 715-c may store computer-readable, computer-executable software/firmware code including instructions that, when executed, cause the processor 705-c to perform various functions described herein (e.g., adaptive short inter-frame space bursting, etc.). Alternatively, the software/firmware code may not be directly executable by the processor 705-c but cause a computer (e.g., when compiled and executed) to perform functions described herein. The processor 705-c may include an intelligent hardware device, (e.g., a central processing unit (CPU), a microcontroller, an ASIC, etc.). In the example of FIG. 8B, the burst traffic manager 810-a and legacy station detector 825-a may be implemented as software/firmware code stored in the memory 715-c and executable by the processor 705-c.

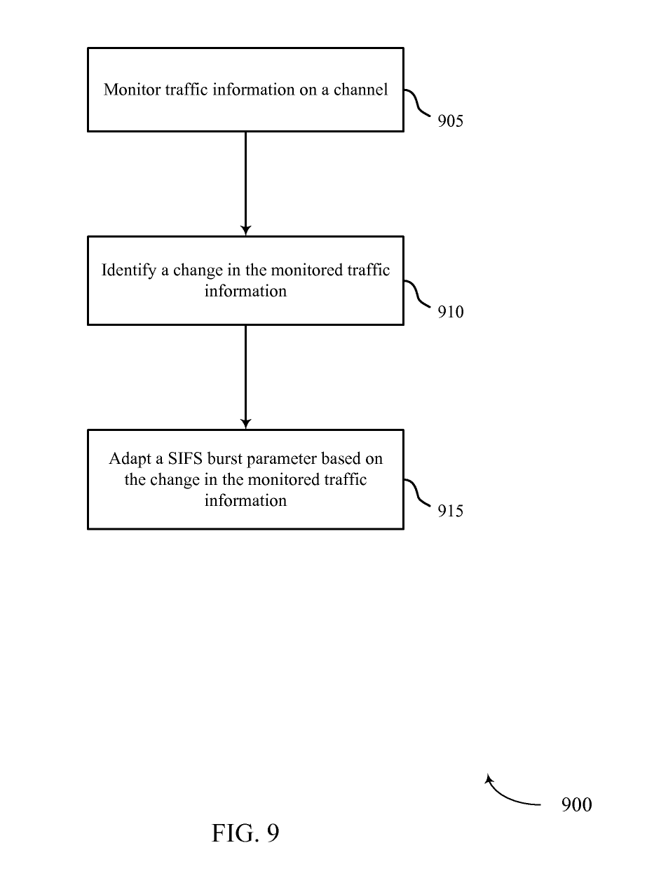

FIG. 9 shows a flowchart illustrating a method 900 for adaptive short inter-frame space bursting in accordance with various aspects of the present disclosure. The operations of method 900 may be implemented by a wireless device 502, STA 115, AP 105 or its components as described with reference to FIGS. 1-9. For example, the operations of method 900 may be performed by the burst traffic manager 510 as described with reference to FIGS. 5-8. A wireless device 502 may execute a set of codes to control the functional elements of the wireless device 502 to perform the functions described below. Additionally or alternatively, the wireless device 502 may perform aspects the functions described below using special-purpose hardware.

At block 905, the wireless device 502 may monitor traffic information on a channel as described above with reference to FIGS. 2-4. In certain examples, the operations of block 905 may be performed by the network traffic monitor 605 as described above with reference to FIG. 6.

At block 910, the wireless device 502 may identify a change in the monitored traffic information as described above with reference to FIGS. 2-4. In certain examples, the operations of block 910 may be performed by the traffic condition identifier 610 as described above with reference to FIG. 6.

At block 915, wireless device 502 may adapt a SIFS burst parameter based at least in part on the change in the monitored traffic information as described above with reference to FIGS. 2-4. In certain examples, the operations of block 915 may be performed by the SIFS burst adapter 615 as described above with reference to FIG. 6.

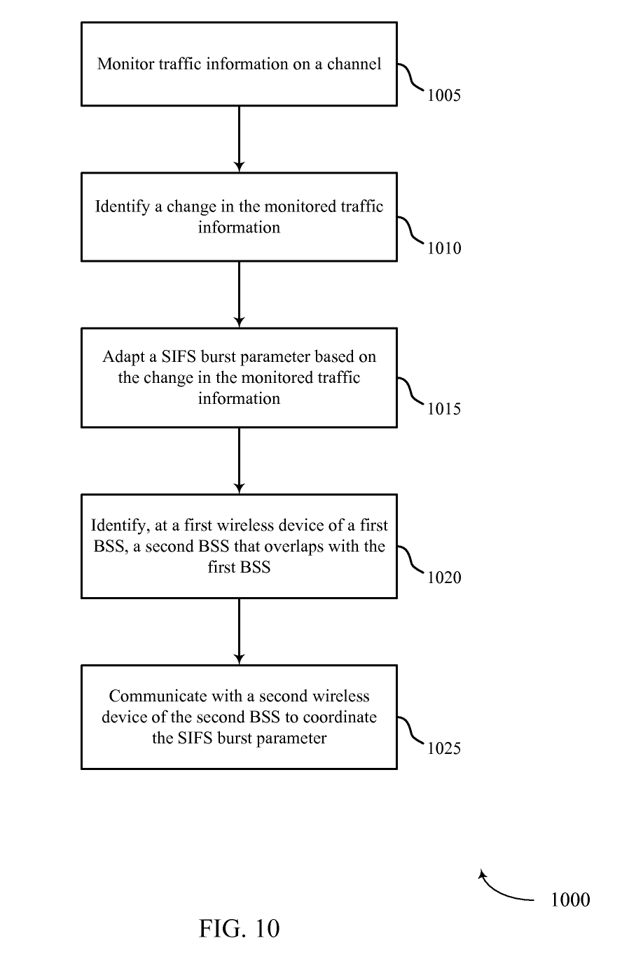

FIG. 10 shows a flowchart illustrating a method 1000 for adaptive short inter-frame space bursting in accordance with various aspects of the present disclosure. The operations of method 1000 may be implemented by a wireless device 502, STA 115, AP 105 or its components as described with reference to FIGS. 1-9. For example, the operations of method 1000 may be performed by the burst traffic manager 510 as described with reference to FIGS. 5-8. A wireless device 502 may execute a set of codes to control the functional elements of the wireless device 502 to perform the functions described below. Additionally or alternatively, the wireless device 502 may perform aspects the functions described below using special-purpose hardware. The method 1000 may also incorporate aspects of method 900 of FIG. 9.

At block 1005, the wireless device 502 may monitor traffic information on a channel as described above with reference to FIGS. 2-4. In certain examples, the operations of block 1005 may be performed by the network traffic monitor 605 as described above with reference to FIG. 6.

At block 1010, the wireless device 502 may identify a change in the monitored traffic information as described above with reference to FIGS. 2-4. In certain examples, the operations of block 1010 may be performed by the traffic condition identifier 610 as described above with reference to FIG. 6.

At block 1015, the wireless device 502 may adapt a SIFS burst parameter based at least in part on the change in the monitored traffic information as described above with reference to FIGS. 2-4. In certain examples, the operations of block 1015 may be performed by the SIFS burst adapter 615 as described above with reference to FIG. 6.

At block 1020, the wireless device 502 may identify, at a first wireless device of a first BSS, a second BSS that overlaps with the first BSS as described above with reference to FIGS. 2-4. In certain examples, the operations of block 1020 may be performed by the BSS overlap identifier 710 as described above with reference to FIGS. 7A-7B.

At block 1025, the wireless device 502 may communicate with a second wireless device of the second BSS to coordinate the SIFS burst parameter as described above with reference to FIGS. 2-4. In certain examples, the operations of block 1025 may be performed by the SIFS coordinator 760 as described above with reference to FIGS. 7A-7B.

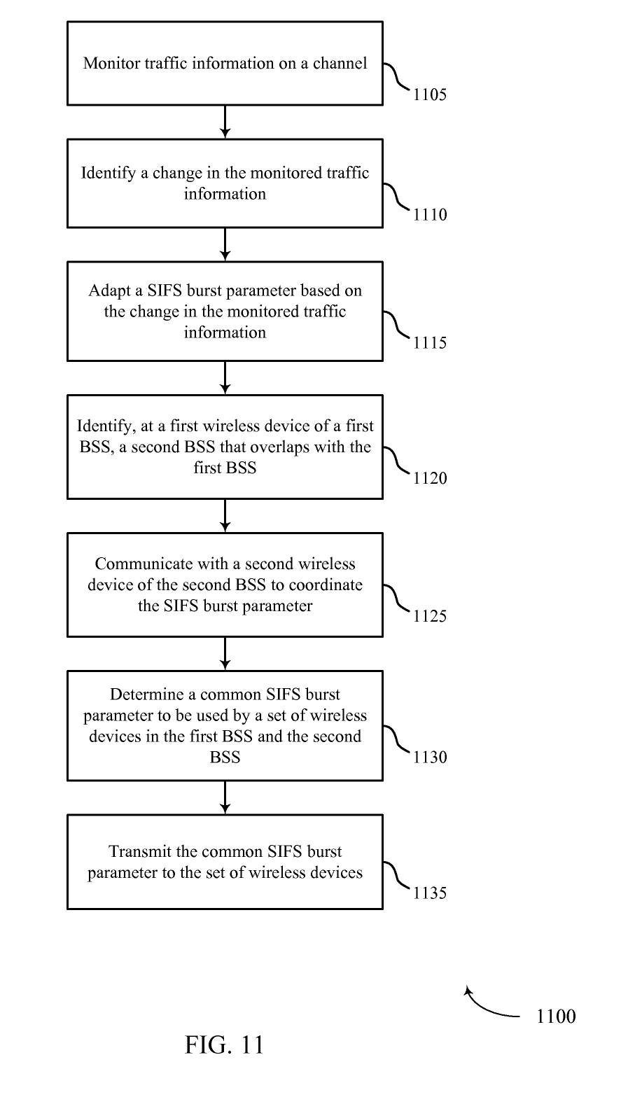

FIG. 11 shows a flowchart illustrating a method 1100 for adaptive short inter-frame space bursting in accordance with various aspects of the present disclosure. The operations of method 1100 may be implemented by a wireless device 502, STA 115, AP 105 or its components as described with reference to FIGS. 1-9. For example, the operations of method 1100 may be performed by the burst traffic manager 510 as described with reference to FIGS. 5-8. A wireless device 502 may execute a set of codes to control the functional elements of the wireless device 502 to perform the functions described below. Additionally or alternatively, the wireless device 502 may perform aspects the functions described below using special-purpose hardware. The method 1100 may also incorporate aspects of methods 900, and 1000 of FIGS. 9-10.

At block 1105, the wireless device 502 may monitor traffic information on a channel as described above with reference to FIGS. 2-4. In certain examples, the operations of block 1105 may be performed by the network traffic monitor 605 as described above with reference to FIG. 6.

At block 1110, the wireless device 502 may identify a change in the monitored traffic information as described above with reference to FIGS. 2-4. In certain examples, the operations of block 1110 may be performed by the traffic condition identifier 610 as described above with reference to FIG. 6.

At block 1115, the wireless device 502 may adapt a SIFS burst parameter based at least in part on the change in the monitored traffic information as described above with reference to FIGS. 2-4. In certain examples, the operations of block 1115 may be performed by the SIFS burst adapter 615 as described above with reference to FIG. 6.

At block 1120, the wireless device 502 may identify, at a first wireless device of a first BSS, a second BSS that overlaps with the first BSS as described above with reference to FIGS. 2-4. In certain examples, the operations of block 1120 may be performed by the BSS overlap identifier 710 as described above with reference to FIGS. 7A-7B.

At block 1125, the wireless device 502 may communicate with a second wireless device of the second BSS to coordinate the SIFS burst parameter as described above with reference to FIGS. 2-4. In certain examples, the operations of block 1125 may be performed by the SIFS coordinator 760 as described above with reference to FIGS. 7A-7B.

At block 1130, the wireless device 502 may determine a common SIFS burst parameter to be used by a plurality of wireless devices in the first BSS and the second BSS as described above with reference to FIGS. 2-4. In certain examples, the operations of block 1130 may be performed by the common SIFS allocator 765 as described above with reference to FIGS. 7A-7B.

At block 1135, the wireless device 502 may transmit the common SIFS burst parameter to the plurality of wireless devices as described above with reference to FIGS. 2-4. In certain examples, the operations of block 1135 may be performed by the transmitter 515 as described above with reference to FIG. 5.

Thus, methods 900, 1000, and 1100 may provide for adaptive short inter-frame space bursting. It should be noted that methods 900, 1000, and 1100 describe possible implementation, and that the operations and the steps may be rearranged or otherwise modified such that other implementations are possible. Aspects from two or more of the methods 1000, 1100, and 1200 may be combined.

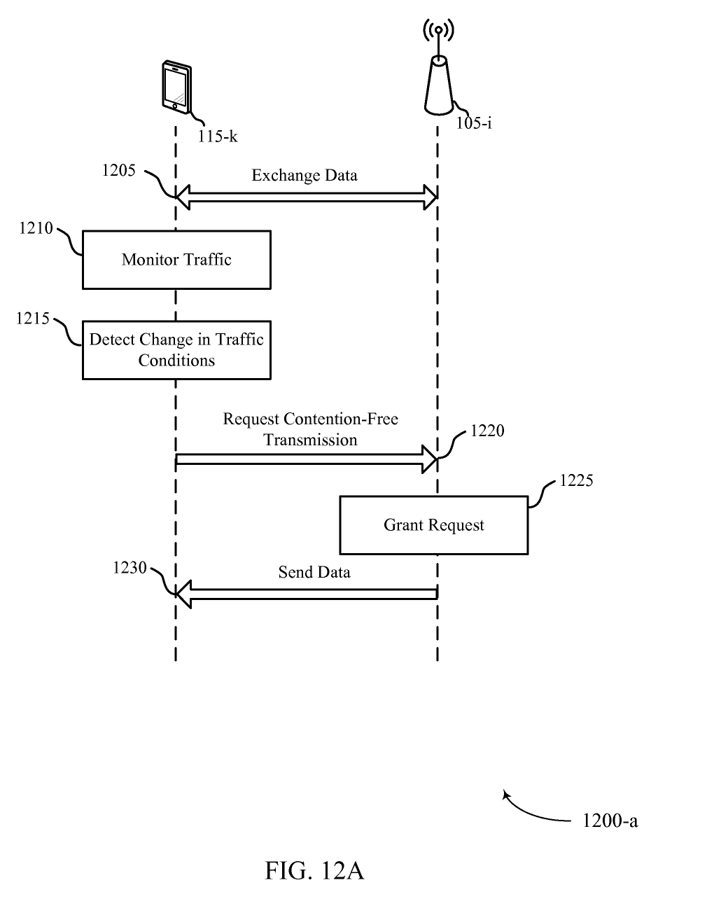

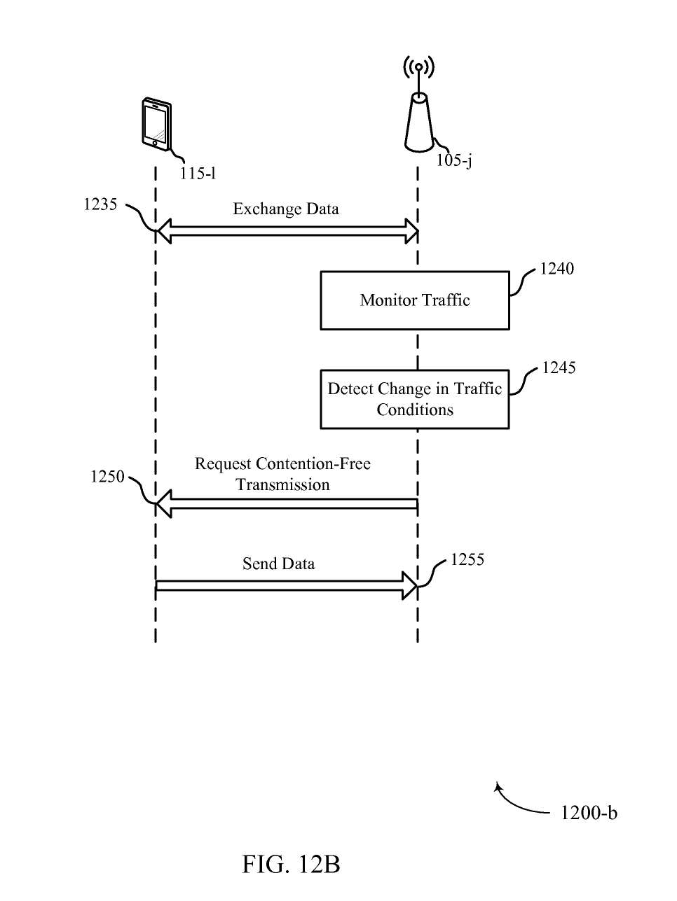

FIG. 12A illustrates an example of communications between an AP 105-i and a STA 115-k for contention-free transmissions in accordance with various aspects of the present disclosure. The STA 115-k may be an example of a STA 115 described above with reference to FIGS. 1-4A and 7A-8B, and the AP 105-i may be an example of an AP 105 described above with reference to FIGS. 1-4A and 7A-8B.

STA 115-k may exchange data 1205 with AP 105-i. At block 1210 STA 115-k may monitor incoming transmissions in addition to on-going transmissions from other STA(s). In some cases, the AP 105-i may concurrently monitor traffic conditions with STA 115-k. STA 115-k, at block 1215, may detect a change in traffic conditions on at least one traffic channel. The detected change in traffic condition may be a change in access categories associated with traffic transmitted over the channel or in the BSS, a change in the amount of uplink or downlink traffic transmitted over the channel or in the BSS, a change in the type or PHY rate of STAs 115 in the BSS, a change in the total number of STAs in the BSS, a change in the number of active flows transmitted over the channel or in the BSS, or a change in the TCP window size associated with traffic transmitted over the channel or in the BSS, or other types of detectable changes in the monitored traffic. These changes may be detected using, for example, the techniques described earlier in the present description.

In some cases, the STA 115-k may notify the AP 105-i of the detected change in traffic conditions. The STA 115-k may request a contention-free transmission 1220 from AP 105-i based on the detected change in traffic conditions. In some examples, the request for a contention-free transmission 1220 may be in the form of a U-APSD.

The AP 105-i may receive the request for a contention-free transmission 1220 and may determine whether to grant the request 1225. The determination to grant the request 1225 for a contention-free transmission may be, for example, in response to a threshold change in an observed traffic conditions metric (e.g., airtime saturation, access fairness, access category, traffic throughput, traffic direction, signal strength, interference, number of STAs in the BSS, type of STAs in the BSS, PHY rate of STAs in the BSS, distribution of traffic to different types of STAs, number of active flows, TCP window size, etc.). In some cases, the AP 105-i may grant a contention-free request 1225 and subsequently send data 1230 to STA 115-k without observing contention protocol.

FIG. 12B illustrates an example of communications between an AP 105-j and a STA 115-1 for contention-free transmissions in accordance with various aspects of the present disclosure. The STA 115-1 may be an example of a STA 115 described above with reference to FIGS. 1-4A and 7A-8B, and the AP 105-j may be an example of an AP 105 described above with reference to FIGS. 1-4A and 7A-8B.

STA 115-1 may exchange data 1235 with AP 105-j, and at block 1240, AP 105-j may monitor transmissions to STA 115-1 in addition to on-going transmissions to other STA(s). AP 105-j, at block 1245, may detect a change in traffic conditions on at least one traffic channel. The change in traffic conditions may be detected using similar techniques to those stated above, with respect to FIG. 12A. In some cases, the AP 105-j may request a contention-free transmission 1250 from STA 115-1 based on the detected change in traffic conditions. In some examples, the request for a contention-free transmission 1250 may be in the form of a reverse direction grant (RDG). The AP 105-j may determine to request a contention free transmission from STA 115-1 using similar criteria as above, with respect to FIG. 12A. The STA 115-k may receive the request and may send data 1255 to AP 105-j without following contention protocols.

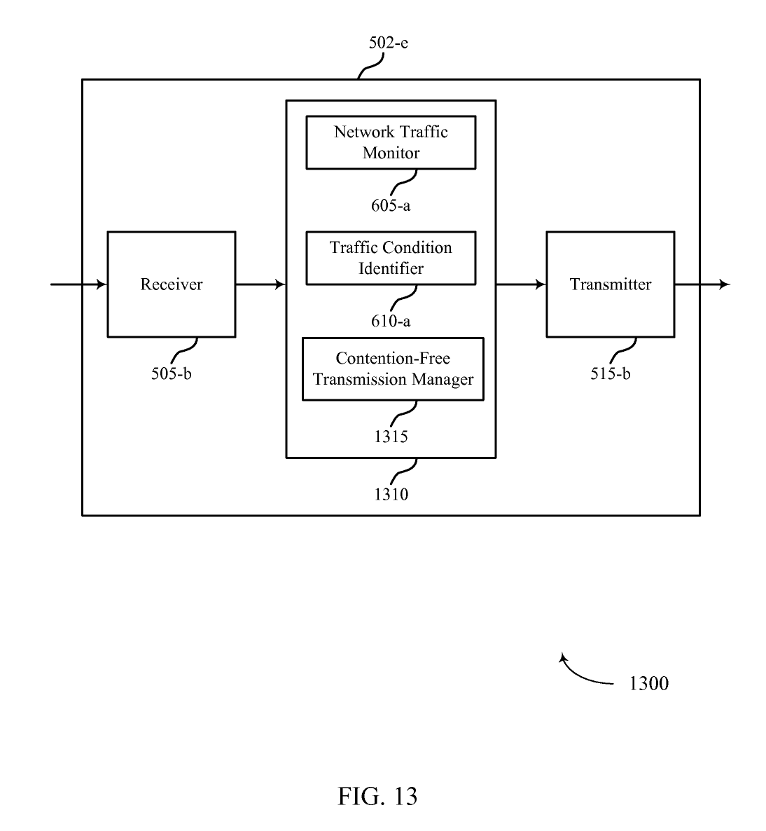

FIG. 13 shows a block diagram 1300 of a wireless device 502-e configured for contention-free transmissions in accordance with various aspects of the present disclosure. The wireless device 502-3 may be an example of aspects of a STA 115 or AP 105 described with reference to FIGS. 1-4. Wireless device 502-e may include a receiver 505-b, a burst traffic manager 1310, or a transmitter 515-b. Wireless device 502 may also include a processor. Each of these components may be in communication with each other.

The components of wireless device 502-e may, individually or collectively, be implemented with at least one application specific integrated circuit (ASIC) adapted to perform some or all of the applicable functions in hardware. Alternatively, the functions may be performed by one or more other processing units (or cores), on at least one IC. Other types of integrated circuits may also be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors. For example, the receiver 505-b may be a hardware receiver, the transmitter 515-b may be a hardware transmitter, and the burst traffic manager 1310 may be a processor and memory to process and store, respectively, the computer readable medium embodying the actions to be taken by the device to manage the burst traffic.

The burst traffic manager 1310 may monitor traffic information on a channel, identify a change in the monitored traffic information, and request a contention free transmission. The burst traffic manager 1310 may include a network traffic monitor 605-a, and a traffic condition identifier 610-a, and a contention-free transmission manager 1315.

The contention-free transmission manager 1315 may request a contention-free transmission as described above with reference to FIGS. 12A-12B. In some cases, the request for a contention-free transmission may be an RDG, which may be sent by a STA 115. In other cases, the request for a contention-free transmission may be a U-APSD, which may be sent by an AP 105.

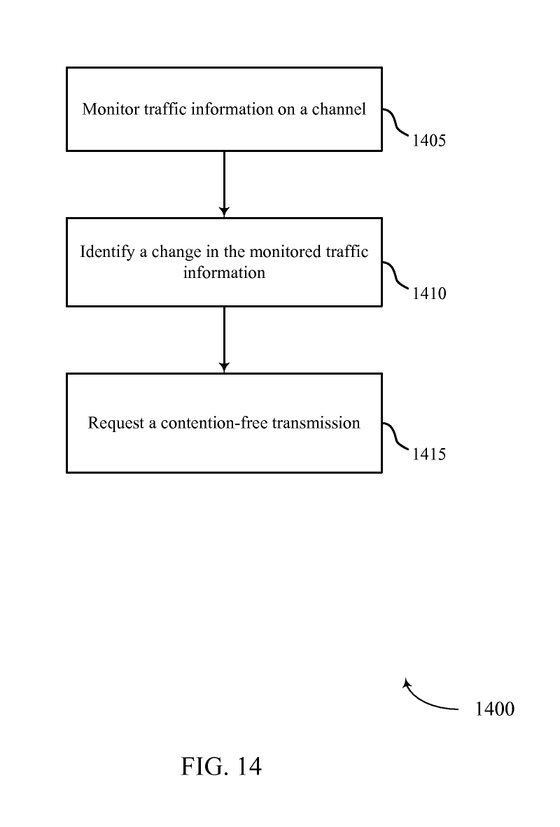

FIG. 14 shows a flowchart illustrating a method 1400 for contention-free transmissions in accordance with various aspects of the present disclosure. The operations of method 1400 may be implemented by a wireless device 502, STA 115, AP 105 or its components as described with reference to FIGS. 1-13. For example, the operations of method 1400 may be performed by the burst traffic manager 1310 as described with reference to FIG. 13. A wireless device 502 may execute a set of codes to control the functional elements of the wireless device 502 to perform the functions described below. Additionally or alternatively, the wireless device 502 may perform aspects the functions described below using special-purpose hardware.

At block 1405, the wireless device 502 may monitor traffic information on a channel as described above with reference to FIG. 2-4, 12A, or 12B. In certain examples, the operations of block 1405 may be performed by the network traffic monitor 605 as described above with reference to FIG. 6 or 13.

At block 1410, the wireless device 502 may identify a change in the monitored traffic information as described above with reference to FIG. 2-4, 12A, or 12B. In certain examples, the operations of block 1410 may be performed by the traffic condition identifier 610 as described above with reference to FIG. 6 or 13.

At block 1415, wireless device 502 may request a contention-free transmission based at least in part on the change in the monitored traffic information as described above with reference to FIG. 12A or 12B. In certain examples, the operations of block 1215 may be performed by the contention-free transmission manager 1315 as described above with reference to FIG. 13.

The detailed description set forth above in connection with the appended drawings describes examples and does not represent all the examples that may be implemented or that are within the scope of the claims. The term “exemplary” used throughout this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the present disclosure.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of wireless communication at a device, comprising:
monitoring traffic information on a channel;
identifying a change in the monitored traffic information; and
adapting a short inter-frame space (SIFS) burst parameter based at least in part on the change in the monitored traffic information.

2. The method of claim 1, further comprising:
transmitting the adapted SIFS burst parameter from a first wireless device to a second wireless device, wherein one of the wireless devices is an access point (AP) and the other of the wireless devices is a station.

3. The method of claim 2, wherein the adapted SIFS burst parameter is transmitted to the second wireless device using a message that is one from the group consisting of:
a management message and a beacon signal.

4. The method of claim 2, further comprising:
receiving a message indicating SIFS bursting capabilities of the second wireless device; wherein the SIFS burst parameter is based at least in part on the SIFS bursting capabilities of the second wireless device.

5. The method of claim 1, further comprising:
identifying, at a first wireless device of a first basic service set (BSS), a second BSS that overlaps with the first BSS; and
communicating with a second wireless device of the second BSS to coordinate the SIFS burst parameter.

6. The method of claim 5, further comprising:
determining a common SIFS burst parameter to be used by a plurality of wireless devices in the first BSS and the second BSS; and
transmitting the common SIFS burst parameter to the plurality of wireless devices.

7. The method of claim 1, further comprising:
disabling SIFS burst transmissions based at least in part on the identified change in the monitored traffic information.

8. The method of claim 1, further comprising:
adjusting a transmission opportunity (TXOP) duration or enhanced distributed channel access (EDCA) parameter based at least in part on the change in the monitored traffic information.

9. The method of claim 1, wherein identifying the change in the monitored traffic information comprises:
detecting at least one legacy station.

10. The method of claim 1, wherein the SIFS burst parameter is selected from the group consisting of:
a duration of an aggregate media access control protocol data unit (A-MPDU), number of A-MPDUs in a burst, a total duration of the burst, and an available bandwidth.

11. The method of claim 1, wherein the SIFS burst parameter comprises a destination-specific SIFS burst parameter.

12. The method of claim 1, wherein the monitored traffic information is selected from the group consisting of:
an access category, a link direction, a number of stations in a BSS, a number of active flows in the BSS, traffic flow information, and a quality of service (QoS) requirement.

13. The method of claim 1, wherein the device is an access point, the method further comprising:
transmitting a reverse direction grant frame to a wireless station based at least in part on the change in the monitored traffic information.

14. The method of claim 1, wherein the device is a wireless station, the method further comprising:
transmitting an unscheduled automatic power save deliver (U-APSD) frame to an access point based at least in part on the change in the monitored traffic information.

15. An apparatus for wireless communication at a device, comprising:
a network traffic monitor for monitoring traffic information on a channel;
a traffic condition identifier for identifying a change in the monitored traffic information; and
a short inter-frame space (SIFS) burst adapter for adapting a SIFS burst parameter based at least in part on the change in the monitored traffic information.

16. The apparatus of claim 15, further comprising:
a transmitter for transmitting the adapted SIFS burst parameter from a first wireless device to a second wireless device, wherein one of the wireless devices is an access point (AP) and the other of the wireless devices is a station.

17. The apparatus of claim 16, wherein the adapted SIFS burst parameter is transmitted to the second wireless device using a message that is one from the group consisting of:
a management message and a beacon signal.

18. The apparatus of claim 16, further comprising:
a SIFS capability identifier for receiving a message indicating SIFS bursting capabilities of the second wireless device; wherein the SIFS burst parameter is based at least in part on the SIFS bursting capabilities of the second wireless device.

19. The apparatus of claim 15, further comprising:
a basic service set (BSS) overlap identifier for identifying, at a first wireless device of a first BSS, a second BSS that overlaps with the first BSS; and
a SIFS coordinator for communicating with a second wireless device of the second BSS to coordinate the SIFS burst parameter.

20. The apparatus of claim 19, further comprising:
a common SIFS allocator for determining a common SIFS burst parameter to be used by a plurality of wireless devices in the first BSS and the second BSS; and
a transmitter for transmitting the common SIFS burst parameter to the plurality of wireless devices.

21. The apparatus of claim 15, further comprising:
a burst transmission disabler for disabling SIFS burst transmissions based at least in part on the identified change in the monitored traffic information.

22. The apparatus of claim 15, further comprising:
a transmission opportunity modifier for adjusting a transmission opportunity (TXOP) duration or enhanced distributed channel access (EDCA) parameter based at least in part on the change in the monitored traffic information.

23. The apparatus of claim 15, further comprising:
a legacy station detector for detecting at least one legacy station.

24. The apparatus of claim 15, wherein the SIFS burst parameter is selected from the group consisting of:
a duration of an aggregate media access control protocol data unit (A-MPDU), number of A-MPDUs in a burst, a total duration of the burst, and an available bandwidth.

25. The apparatus of claim 15, wherein the SIFS burst parameter comprises a destination-specific SIFS burst parameter.

26. The apparatus of claim 15, wherein the monitored traffic information is selected from the group consisting of:
an access category, a link direction, a number of stations in a BSS, a number of active flows in the BSS, traffic flow information, and a quality of service (QoS) requirement.

27. The apparatus of claim 15, wherein the device is an access point, the apparatus further comprising:
a transmitter to transmit a reverse direction grant frame to a wireless station based at least in part on the change in the monitored traffic information.

28. The apparatus of claim 15, wherein the device is a wireless station, the apparatus further comprising:
a transmitter to transmit an unscheduled automatic power save deliver (U-APSD) frame to an access point based at least in part on the change in the monitored traffic information.

29. An apparatus for wireless communication, comprising:
means for monitoring traffic information on a channel;
means for identifying a change in the monitored traffic information; and
means for adapting a short inter-frame space (SIFS) burst parameter based at least in part on the change in the monitored traffic information.

30. The apparatus of claim 29, further comprising:
means for transmitting the adapted SIFS burst parameter from a first wireless device to a second wireless device, wherein one of the wireless devices is an access point (AP) and the other of the wireless devices is a station.

31. The apparatus of claim 30, wherein the adapted SIFS burst parameter is transmitted to the second wireless device using a message that is one from the group consisting of:
a management message and a beacon signal.

32. The apparatus of claim 30, further comprising:
means for receiving a message indicating SIFS bursting capabilities of the second wireless device; wherein the SIFS burst parameter is based at least in part on the SIFS bursting capabilities of the second wireless device.

33. The apparatus of claim 29, further comprising:
means for identifying, at a first wireless device of a first basic service set (BSS), a second BSS that overlaps with the first BSS; and
means for communicating with a second wireless device of the second BSS to coordinate the SIFS burst parameter.

34. The apparatus of claim 33, further comprising:
means for determining a common SIFS burst parameter to be used by a plurality of wireless devices in the first BSS and the second BSS; and
means for transmitting the common SIFS burst parameter to the plurality of wireless devices.

35. The apparatus of claim 29, further comprising:
means for disabling SIFS burst transmissions based at least in part on the identified change in the monitored traffic information.

36. The apparatus of claim 29, further comprising:
means for adjusting a transmission opportunity (TXOP) duration or enhanced distributed channel access (EDCA) parameter based at least in part on the change in the monitored traffic information.

37. The apparatus of claim 29, wherein the means for identifying the change in the monitored traffic information comprises:
means for detecting at least one legacy station.

38. The apparatus of claim 29, wherein the SIFS burst parameter is selected from the group consisting of:
a duration of an aggregate media access control protocol data unit (A-MPDU), number of A-MPDUs in a burst, a total duration of the burst, and an available bandwidth.

39. The apparatus of claim 29, wherein the SIFS burst parameter comprises a destination-specific SIFS burst parameter.

40. The apparatus of claim 29, wherein the monitored traffic information is selected from the group consisting of:
an access category, a link direction, a number of stations in a BSS, a number of active flows in the BSS, traffic flow information, and a quality of service (QoS) requirement.

41. The apparatus of claim 29, wherein the apparatus is an access point, the apparatus further comprising:
means for transmitting a reverse direction grant frame to a wireless station based at least in part on the change in the monitored traffic information.

42. The apparatus of claim 29, wherein the apparatus is a wireless station, the apparatus further comprising:
means for transmitting an unscheduled automatic power save deliver (U-APSD) frame to an access point based at least in part on the change in the monitored traffic information.

43. A non-transitory computer-readable medium storing code for wireless communication at a device, the code comprising instructions executable to cause the device to:
monitor traffic information on a channel;
identify a change in the monitored traffic information; and
adapt a short inter-frame space (SIFS) burst parameter based at least in part on the change in the monitored traffic information.

44. The non-transitory computer-readable medium of claim 43, wherein the code further comprises instructions executable to cause the device to:
transmit the adapted SIFS burst parameter from a first wireless device to a second wireless device, wherein one of the wireless devices is an access point (AP) and the other of the wireless devices is a station.

45. The non-transitory computer-readable medium of claim 44, wherein the adapted SIFS burst parameter is transmitted to the second wireless device using a message that is one from the group consisting of:
a management message and a beacon signal.

46. The non-transitory computer-readable medium of claim 44, wherein the code further comprises instructions executable to cause the device to:
receive a message indicating SIFS bursting capabilities of the second wireless device; wherein the SIFS burst parameter is based at least in part on the SIFS bursting capabilities of the second wireless device.

47. The non-transitory computer-readable medium of claim 43, wherein the code further comprises instructions executable to cause the device to:
identify, at a first wireless device of a first basic service set (BSS), a second BSS that overlaps with the first BSS; and
communicate with a second wireless device of the second BSS to coordinate the SIFS burst parameter.

48. The non-transitory computer-readable medium of claim 47, wherein the code further comprises instructions executable to cause the device to:
determine a common SIFS burst parameter to be used by a plurality of wireless devices in the first BSS and the second BSS; and
transmit the common SIFS burst parameter to the plurality of wireless devices.

49. The non-transitory computer-readable medium of claim 43, wherein the code further comprises instructions executable to cause the device to:
disable SIFS burst transmissions based at least in part on the identified change in the monitored traffic information.

50. The non-transitory computer-readable medium of claim 43, wherein the code further comprises instructions executable to cause the device to:
adjust a transmission opportunity (TXOP) duration or enhanced distributed channel access (EDCA) parameter based at least in part on the change in the monitored traffic information.

51. The non-transitory computer-readable medium of claim 43, wherein identifying the change in the monitored traffic information comprises:
detecting at least one legacy station.

52. The non-transitory computer-readable medium of claim 43, wherein the SIFS burst parameter is selected from the group consisting of:
a duration of an aggregate media access control protocol data unit (A-MPDU), number of A-MPDUs in a burst, a total duration of the burst, and an available bandwidth.

53. The non-transitory computer-readable medium of claim 43, wherein the SIFS burst parameter comprises a destination-specific SIFS burst parameter.

54. The non-transitory computer-readable medium of claim 43, wherein the monitored traffic information is selected from the group consisting of:
an access category, a link direction, a number of stations in a BSS, a number of active flows in the BSS, traffic flow information, and a quality of service (QoS) requirement.

55. The non-transitory computer-readable medium of claim 43, wherein the device is an access point and the code further comprises instructions executable to cause the device to:
transmit a reverse direction grant frame to a wireless station based at least in part on the change in the monitored traffic information.

56. The non-transitory computer-readable medium of claim 43, wherein the device is a wireless station and the code further comprises instructions executable to cause the device to:
transmit an unscheduled automatic power save deliver (U-APSD) frame to an access point based at least in part on the change in the monitored traffic information.
